(19) United States
(12) Patent Application Publication
(10) Pub. No.: US 2023/0388823 A1
(43) Pub. Date: Nov. 30, 2023

(54) NETWORK ISSUE INFORMATION OBTAINING METHOD AND APPARATUS, AND SYSTEM

(71) Applicant: HUAWEI TECHNOLOGIES CO., LTD., Shenzhen (CN)

(72) Inventors: Ruiyue XU, Shanghai (CN); Lan ZOU, Shanghai (CN); Kai ZHANG, Shanghai (CN)

(21) Appl. No.: 18/366,379

(22) Filed: Aug. 7, 2023

Related U.S. Application Data
(63) Continuation of application No. PCT/CN2022/072374, filed on Jan. 17, 2022.

(30) Foreign Application Priority Data
Feb. 9, 2021 (CN) 202110179319.5

(51) Int. Cl. H04W 24/04; H04W 28/02

(52) U.S. Cl. CPC H04W 24/04; H04W 28/0236

(57) ABSTRACT

A network issue information obtaining method, apparatus, and system. First information about a network issue is determined. The first information is sent to a second apparatus. The first information includes one or more of the following: identification information of the network issue, diagnosis information of the network issue, or recovery information of the network issue. The diagnosis information describes an analysis result of the network issue. The recovery information describes a recovery status of the network issue.

### CROSS-REFERENCE TO RELATED APPLICATIONS

This application is a continuation of International Application No. PCT/CN2022/072374, filed on Jan. 17, 2022, which claims priority to Chinese Patent Application No. 202110179319.5, filed on Feb. 9, 2021. The disclosures of the aforementioned applications are hereby incorporated by reference in their entireties.

### BACKGROUND

With introduction of the vertical industry (for example, the public transport industry, the industrial manufacturing industry, or the automobile industry), increase of terminal devices, and diversification of services, operator networks become more and more complex, which results in larger difficulty in network operation&maintenance and lower network operation&maintenance efficiency.

Currently, an operator network device, such as a cross domain management function (cross domain management function) unit, and a vendor network device, such as a domain management function (domain management function) unit, jointly complete a network operation&maintenance operation. Specifically, the vendor network device completes a network operation&maintenance task, for example, adjusts a data transmission rate or increases transmit power of a base station, based on an indication of the operator network device. However, the operator network device is not able to obtain information about a network issue, for example, a cause, time, and a location of the network issue. Therefore, the sent indication is neither accurate nor timely. Consequently, the network issue is not able to be resolved in time, resulting in low network operation& maintenance efficiency.

### SUMMARY

Embodiments described herein provide a network issue information obtaining method and apparatus, and a system, to improve network operation&maintenance efficiency of an operator network device.

To achieve the foregoing objective, at least one embodiment uses the following technical solutions.

According to a first aspect, a network issue information obtaining method is provided. The method is applied to a first apparatus. The method includes: determining first information about a network issue; and sending the first information to a second apparatus. The first information includes one or more of the following: identification information of the network issue (issue recognition info, or issue identification info), and diagnosis information of the network issue (issue diagnosis info or issue analysis info), or recovery information of the network issue (issue recovery info, or issue healing info), the diagnosis information describes an analysis result of the network issue, and the recovery information describes a recovery status of the network issue.

Based on the network issue information obtaining method according to the first aspect and a network issue information obtaining method according to the second aspect, the first apparatus is a vendor network device, and the second apparatus is an operator network device. The vendor network device sends the first information about the network issue to the operator network device in real time, and the operator network device determines, in real time based on the first information, an operation for processing the network issue. In other words, the operator network device manages, controls, and resolves the network issue in a network in real time. This improves network operation&maintenance efficiency.

In addition, in response to the vendor network device detecting that a weak-coverage network issue in an area 1, but actually because the area 1 has a few users, the weak-coverage network issue in the area 1 does not need to be resolved. After receiving the network issue, the operator network device indicates the vendor network device to ignore the network issue. In other words, the operator network device further indicates the vendor network device to resolve a network issue that the operator network device expects to resolve, so as to prevent the vendor network device from resolving a network issue that the operator network device does not expect to resolve. This further improves network operation&maintenance efficiency.

The first information is also referred to as information about the network issue (issue info), and the identification information of the network issue is also referred to as discovery information of the network issue.

In at least one embodiment, the network issue includes one or more of the following: a network fault, a network exception, or a network performance indicator exception. In this way, the operator network device manages, controls, and resolves the network issue, such as the network fault, the network exception, or the network performance indicator exception, in a network in real time. This improves network operation&maintenance efficiency. In addition, information such as the network fault, the network exception, or the network performance indicator exception is integrated into one piece of information (namely, the network issue), so that a plurality of interfaces between the first apparatus and the second apparatus is integrated into one interface. This reduces interface interaction complexity, improves information integration efficiency, and further improves network operation&maintenance efficiency.

The network performance indicator exception is also referred to as that a network performance indicator does not meet a predetermined value.

In at least one embodiment, the identification information of the network issue includes one or more of the following: a type of the network issue (issue type), or an object of the network issue (issue object). The type of the network issue includes one or more of the following: coverage, a rate, a capacity, a device fault, service experience (service experience), mobility, or energy consumption. The coverage describes an issue in network coverage, the rate describes an issue in a network rate, the capacity describes an issue in a network capacity, the service experience describes an issue in network service experience, the mobility describes an issue in network mobility, energy consumption describes an issue in network energy consumption, and the device fault describes a fault in a network device. The object of the network issue includes one or more of the following: location information (for example, a geographic grid, a geographic area, or longitude and latitude of a geographic grid), a network element, a cell, or a terminal user.

Optionally, the coverage corresponds to one or more of the following network issues: a coverage rate is less than a first coverage rate threshold, a coverage rate is greater than a second coverage rate threshold, reference signal received power is less than a reference signal received power threshold, a signal to interference plus noise ratio is less than a signal to interference plus noise ratio threshold, or there is no coverage. In addition, the coverage also corresponds to one or more of the following network issues: a coverage vulnerability in a network, a mismatch between uplink and downlink coverage of a network, or pilot contamination in a network. The rate corresponds to one or more of the following network issues: the rate is less than a first rate threshold (for example, an average rate is less than an average rate threshold, or a peak rate is less than a peak rate threshold), a quantity of low-rate users is greater than a first quantity threshold, or a quantity of high-rate users is less than a second quantity threshold. The low-rate user is a user whose rate is less than a second rate threshold, and the high-rate user is a user whose rate is greater than a third rate threshold. The capacity corresponds to one or more of the following network issues: network load is greater than a load threshold, network load is unbalanced, or a network is congested. The device fault corresponds to one or more of the following network issues: a base station fault, a fronthaul fault, an optical interface fault, a clock fault, a cell fault, or a standing wave fault. The service experience corresponds to one or more of the following network issues: a delay is greater than a delay threshold, a delay jitter is greater than a delay jitter threshold, an access success rate is less than an access success rate threshold, a call drop rate is greater than a call drop rate threshold, a packet loss rate is greater than a packet loss rate threshold, or a mean opinion score (mean opinion score, MOS) is less than a mean opinion score threshold. The mean opinion score describes voice or video quality. The mobility corresponds to one or more of the following network issues: a handover success rate is less than a handover success rate threshold, a premature handover rate is greater than a premature handover rate threshold, a delayed handover rate is greater than a delayed handover rate threshold, or a ping-pong handover rate is greater than a ping-pong handover rate threshold. The energy consumption corresponds to one or more of the following network issues: the energy consumption is greater than an energy consumption threshold, or a traffic volume is low but the energy consumption is high (is referred to as that a traffic volume is lower than a traffic volume threshold but energy consumption is greater than an energy consumption threshold).

In the network issue corresponding to the coverage, that the coverage rate is less than the first coverage rate threshold is also referred to as weak coverage, that the coverage rate is greater than the second coverage rate threshold is also referred to as over-coverage, that the reference signal received power is less than the reference signal received power threshold is also referred to as low reference signal received power, and that the signal to interference plus noise ratio is less than the signal to interference plus noise ratio threshold is also referred to as a small signal to interference plus noise ratio. In the network issue corresponding to the rate, that the rate is less than the first rate threshold is also referred to as a low rate, that the quantity of low-rate users is greater than the first quantity threshold is also referred to as a large quantity of low-rate users, and that the quantity of high-rate users is less than the second quantity threshold is also referred to as a small quantity of high-rate users. In the network issue corresponding to the capacity, that the network load is greater than the load threshold is also referred to as high load. In the network issue corresponding to the service experience, that the delay is greater than the delay threshold is also referred to as a large delay, that the delay jitter is greater than the delay jitter threshold is also referred to as a large delay jitter, that the access success rate is less than the access success rate threshold is also referred to as a low access success rate, that the call drop rate is greater than the call drop rate threshold, and that the packet loss rate is greater than the packet loss rate threshold each is also referred to as a high packet loss rate. In the network issue corresponding to the mobility, that the handover success rate is less than the handover success rate threshold is also referred to as a low handover success rate, that the premature handover rate is greater than the premature handover rate threshold is also referred to as a high premature handover rate, that the delayed handover rate is greater than the delayed handover rate threshold is also referred to as a high delayed handover rate, and that the ping-pong handover (ping-pong handover) rate is greater than the ping-pong handover rate threshold is also referred to as a frequent ping-pong handover or a large ping-pong handover rate. In the network issue corresponding to the energy consumption, that the energy consumption is greater than the energy consumption threshold is also referred to as high energy consumption.

For example, in the identification information of the network issue, in response to a type of the network issue being the service experience, the network issue corresponding to the service experience is that the delay is greater than the delay threshold, and the object of the network issue is a network element 1, the operator network device determines, based on the identification information of the network issue, an operation for processing the network issue in the network element 1, so as to resolve the network issue targetedly. In other words, the identification information of the network issue is classified in detail, so that the identification information of the network issue is more accurate and detailed. The operator network device obtains the detailed identification information of the network issue in real time, and accurately locate the network issue, thereby improving precision of identifying the network issue by the operator network device. In addition, the operation for processing the network issue is targetedly determined, so that the network issue in the network is accurately and effectively resolved, and network operation&maintenance efficiency is improved.

The identification information of the network issue further includes a name of the network issue (issue name), and the name of the network issue includes the network issue corresponding to the coverage, the network issue corresponding to the rate, the network issue corresponding to the capacity, the network issue corresponding to the device fault, the network issue corresponding to the service experience, the network issue corresponding to the mobility, or the network issue corresponding to the energy consumption.

In at least one embodiment, the diagnosis information of the network issue includes one or more of the following: a cause of the network issue (issue root cause), a recovery capability corresponding to the network issue (issue recovery capability), a recovery suggestion for the network issue (issue recovery recommendation), or a predicted recovery result (predicted recovery result) of the network issue. The recovery capability corresponding to the network issue includes: the first apparatus recovers the network issue or the first apparatus is not able to recover the network issue. The recovery suggestion for the network issue includes an operation of the first apparatus to recover the network issue. The predicted recovery result of the network issue includes a predicted network performance indicator obtained after the network issue is recovered.

The network issue that the first apparatus recovers is referred to as recoverable, and the network issue that the first apparatus is not able to recover is referred to as unrecoverable.

For example, in the diagnosis information of the network issue, in response to the cause of the network issue being that a parameter of a cell is configured inappropriately, the recovery capability corresponding to the network issue is that the first apparatus recovers the network issue, the recovery suggestion for the network issue is a configuration parameter of the cell, and the predicted recovery result of the network issue is a predicted rate that is achieved by a network after the recovery, the operator network device determines, based on the diagnosis information of the network issue, an operation for processing the network issue (for example, configure the cell based on the configuration parameter of the cell in the recovery suggestion for the network issue), so as to targetedly resolve the network issue. In other words, the diagnosis information of the network issue is classified in detail, so that the diagnosis information of the network issue is more accurate and detailed. The operator network device obtains the detailed diagnosis information of the network issue in real time, and accurately locate the network issue, thereby improving precision of identifying the network issue by the operator network device. In addition, the operation for processing the network issue is targetedly determined, so that the network issue in the network is accurately and effectively resolved, and network operation&maintenance efficiency is improved.

In at least one embodiment, the recovery information of the network issue includes one or more of the following: a recovery status of the network issue (issue recovery status), or a recovery result of the network issue (issue recovery result). The recovery status of the network issue includes not recovered or being recovered, and the recovery result of the network issue includes successfully recovered, or failed to be recovered. In other words, the recovery information of the network issue includes one or more of the following: not recovered, being recovered, successfully recovered, or failed to be recovered.

For example, in response to the recovery information of the network issue being recovered, the operator network device determines, based on the recovery information of the network issue, an operation for processing the network issue (for example, periodically query a recovery progress of the network issue), so as to targetedly resolve the network issue. In other words, the recovery information of the network issue is classified in detail, so that the recovery information of the network issue is more accurate and detailed. The operator network device obtains the detailed recovery information of the network issue in real time, and accurately locate the network issue, thereby improving precision of identifying the network issue by the operator network device. In addition, the operation for processing the network issue is targetedly determined, so that the network issue in the network is accurately and effectively resolved, and network operation&maintenance efficiency is improved.

In at least one embodiment, before the determining first information, the network issue information obtaining method according to the first aspect further includes: receiving a first request from the second apparatus. The first request includes one or more of the following: a network issue query condition or network issue indication information. The network issue query condition is used to indicate the first apparatus to feed back the first information that meets the network issue query condition. The network issue indication information indicates the first apparatus to feed back one or more of the following: the identification information of the network issue, the diagnosis information of the network issue, or the recovery information of the network issue. In this way, the operator network device obtains the specified network issue in time by sending the first request to the vendor network device. This manages, controls, and resolves the specified network issue and improve network operation&maintenance efficiency.

The first request is also referred to as a query request (query request).

In at least one embodiment, before the determining first information, the network issue information obtaining method according to the first aspect further includes: receiving a second request from the second apparatus. The second request carries a network issue subscription condition, and the network issue subscription condition is used to indicate that the first apparatus feeds back the first information in response to the first information that meets the network issue subscription condition being generated or updated. In other words, the operator network device continuously obtains a specified and latest network issue by sending the second request to the vendor network device. This manages, controls, and resolves the specified network issue in time, and improve network operation&maintenance efficiency.

The second request is also referred to as a subscription request (subscription request).

According to a second aspect, a network issue information obtaining method is provided. The method is applied to a second apparatus. The method includes: receiving first information about a network issue from a first apparatus, and determining, based on the first information, an operation for processing the network issue. The first information includes one or more of the following: identification information of the network issue, diagnosis information of the network issue, or recovery information of the network issue, the diagnosis information describes an analysis result of the network issue, and the recovery information describes a recovery status of the network issue.

In at least one embodiment, the network issue includes one or more of the following: a network fault, a network exception, or a network performance indicator exception.

In at least one embodiment, the identification information of the network issue includes one or more of the following: a type of the network issue (issue type), or an object of the network issue (issue object). The type of the network issue includes one or more of the following: coverage, a rate, a capacity, a device fault, service experience (service experience), mobility, or energy consumption. The coverage describes a coverage issue of a network, the capacity describes a capacity issue of the network, and the mobility describes a mobility issue of the network. The object of the network issue includes one or more of the following: location information (for example, a geographic grid, a geographic area, or longitude and latitude of a geographic grid), a network element, a cell, or a terminal user.

Optionally, the coverage corresponds to one or more of the following network issues: a coverage rate is less than a first coverage rate threshold, a coverage rate is greater than a second coverage rate threshold, reference signal received power is less than a reference signal received power threshold, a signal to interference plus noise ratio is less than a signal to interference plus noise ratio threshold, or there is no coverage. In addition, the coverage also corresponds to one or more of the following network issues: a coverage vulnerability in a network, a mismatch between uplink and downlink coverage of a network, or pilot contamination in a network. The rate corresponds to one or more of the following network issues: the rate is less than a first rate threshold (for example, an average rate is less than an average rate threshold, or a peak rate is less than a peak rate threshold), a quantity of low-rate users is greater than a first quantity threshold, or a quantity of high-rate users is less than a second quantity threshold. The low-rate user is a user whose rate is less than a second rate threshold, and the high-rate user is a user whose rate is greater than a third rate threshold. The capacity corresponds to one or more of the following network issues: network load is greater than a load threshold, network load is unbalanced, or a network is congested. The device fault corresponds to one or more of the following network issues: a base station fault, a fronthaul fault, an optical interface fault, a clock fault, a cell fault, or a standing wave fault. The service experience corresponds to one or more of the following network issues: a delay is greater than a delay threshold, a delay jitter is greater than a delay jitter threshold, an access success rate is less than an access success rate threshold, a call drop rate is greater than a call drop rate threshold, a packet loss rate is greater than a packet loss rate threshold, or a mean opinion score is less than a mean opinion score threshold. The mean opinion score describes voice or video quality. The mobility corresponds to one or more of the following network issues: a handover success rate is less than a handover success rate threshold, a premature handover rate is greater than a premature handover rate threshold, a delayed handover rate is greater than a delayed handover rate threshold, or a ping-pong handover rate is greater than a ping-pong handover rate threshold. The energy consumption corresponds to one or more of the following network issues: the energy consumption is greater than an energy consumption threshold, or a traffic volume is low but the energy consumption is high (for example, a traffic volume is lower than a traffic volume threshold but the energy consumption is greater than an energy consumption threshold).

In at least one embodiment, the diagnosis information of the network issue includes one or more of the following: a cause of the network issue, a recovery capability corresponding to the network issue, a recovery suggestion for the network issue, or a predicted recovery result of the network issue. The recovery capability corresponding to the network issue includes: the first apparatus recovers the network issue or the first apparatus is not able to recover the network issue. The recovery suggestion for the network issue includes an operation of the first apparatus to recover the network issue. The predicted recovery result of the network issue includes a predicted network performance indicator obtained after the network issue is recovered.

In at least one embodiment, the recovery information of the network issue includes one or more of the following: a recovery status of the network issue, or a recovery result of the network issue. The recovery status of the network issue includes not recovered or being recovered, and the recovery result of the network issue includes successfully recovered, or failed to be recovered. In other words, the recovery information of the network issue includes one or more of the following: not recovered, being recovered, successfully recovered, or failed to be recovered.

In at least one embodiment, before the receiving first information about a network issue from a first apparatus, the network issue information obtaining method according to the second aspect further includes: sending a first request to the first apparatus. The first request includes one or more of the following: a network issue query condition or network issue indication information. The network issue query condition is used to indicate the first apparatus to feed back the first information that meets the network issue query condition. The network issue indication information indicates the first apparatus to feed back one or more of the following: the identification information of the network issue, the diagnosis information of the network issue, or the recovery information of the network issue.

In at least one embodiment, before the receiving first information about a network issue from a first apparatus, the network issue information obtaining method according to the second aspect further includes: sending a second request to the first apparatus. The second request carries a network issue subscription condition, and the network issue subscription condition is used to indicate that the first apparatus feeds back the first information in response to the first information that meets the network issue subscription condition being generated or updated.

In addition, for technical effect of the network issue information obtaining method according to the second aspect, refer to the technical effect of the network issue information obtaining method according to the first aspect. Details are not described herein again.

According to a third aspect, a network issue information obtaining apparatus is provided. The network issue information obtaining apparatus includes a processing module and a transceiver module. The processing module is configured to determine first information about a network issue. The first information includes one or more of the following: identification information of the network issue, diagnosis information of the network issue, or recovery information of the network issue, the diagnosis information describes an analysis result of the network issue, and the recovery information describes a recovery status of the network issue. The transceiver module is configured to send the first information to a second apparatus.

In at least one embodiment, the network issue includes one or more of the following: a network fault, a network exception, or a network performance indicator exception.

In at least one embodiment, the identification information of the network issue includes one or more of the following: a type of the network issue, or an object of the network issue (issue object). The type of the network issue includes one or more of the following: coverage, a rate, a capacity, a device fault, service experience, mobility, or energy consumption. The coverage describes a coverage issue of a network, the capacity describes a capacity issue of the network, and the mobility describes a mobility issue of the network. The object of the network issue includes one or more of the following: location information (for example, a geographic grid, a geographic area, or longitude and latitude of a geographic grid), a network element, a cell, or a terminal user.

Optionally, the coverage corresponds to one or more of the following network issues: a coverage rate is less than a first coverage rate threshold, a coverage rate is greater than a second coverage rate threshold, reference signal received power is less than a reference signal received power threshold, a signal to interference plus noise ratio is less than a signal to interference plus noise ratio threshold, or there is no coverage. In addition, the coverage also corresponds to one or more of the following network issues: a coverage vulnerability in a network, a mismatch between uplink and downlink coverage of a network, or pilot contamination in a network. The rate corresponds to one or more of the following network issues: the rate is less than a first rate threshold (for example, an average rate is less than an average rate threshold, or a peak rate is less than a peak rate threshold), a quantity of low-rate users is greater than a first quantity threshold, or a quantity of high-rate users is less than a second quantity threshold. The low-rate user is a user whose rate is less than a second rate threshold, and the high-rate user is a user whose rate is greater than a third rate threshold. The capacity corresponds to one or more of the following network issues: network load is greater than a load threshold, network load is unbalanced, or a network is congested. The device fault corresponds to one or more of the following network issues: a base station fault, a fronthaul fault, an optical interface fault, a clock fault, a cell fault, or a standing wave fault. The service experience corresponds to one or more of the following network issues: a delay is greater than a delay threshold, a delay jitter is greater than a delay jitter threshold, an access success rate is less than an access success rate threshold, a call drop rate is greater than a call drop rate threshold, a packet loss rate is greater than a packet loss rate threshold, or a mean opinion score is less than a mean opinion score threshold. The mean opinion score describes voice or video quality. The mobility corresponds to one or more of the following network issues: a handover success rate is less than a handover success rate threshold, a premature handover rate is greater than a premature handover rate threshold, a delayed handover rate is greater than a delayed handover rate threshold, or a ping-pong handover rate is greater than a ping-pong handover rate threshold. The energy consumption corresponds to one or more of the following network issues: the energy consumption is greater than an energy consumption threshold, or a traffic volume is low but the energy consumption is high (for example, a traffic volume is lower than a traffic volume threshold but energy consumption is greater than an energy consumption threshold).

In at least one embodiment, the diagnosis information of the network issue includes one or more of the following: a cause of the network issue, a recovery capability corresponding to the network issue, a recovery suggestion for the network issue, or a predicted recovery result of the network issue. The recovery capability corresponding to the network issue includes: the first apparatus recovers the network issue or the first apparatus is not able to recover the network issue. The recovery suggestion for the network issue includes an operation of the first apparatus to recover the network issue. The predicted recovery result of the network issue includes a predicted network performance indicator obtained after the network issue is recovered.

In at least one embodiment, the recovery information of the network issue includes one or more of the following: a recovery status of the network issue, or a recovery result of the network issue. The recovery status of the network issue includes not recovered or being recovered, and the recovery result of the network issue includes successfully recovered, or failed to be recovered. In other words, the recovery information of the network issue includes one or more of the following: not recovered, being recovered, successfully recovered, or failed to be recovered.

In at least one embodiment, the transceiver module is further configured to receive a first request from the second apparatus. The first request includes one or more of the following: a network issue query condition or network issue indication information. The network issue query condition is used to indicate the first apparatus to feed back the first information that meets the network issue query condition. The network issue indication information indicates the first apparatus to feed back one or more of the following: the identification information of the network issue, the diagnosis information of the network issue, or the recovery information of the network issue.

In at least one embodiment, the transceiver module is further configured to receive a second request from the second apparatus. The second request carries a network issue subscription condition, and the network issue subscription condition is used to indicate that the first apparatus feeds back the first information in response to the first information that meets the network issue subscription condition being generated or updated.

Optionally, the transceiver module includes a receiving module and a sending module. The receiving module is configured to implement a receiving function of the network issue information obtaining apparatus according to the third aspect, and the sending module is configured to implement a sending function of the network issue information obtaining apparatus according to the third aspect.

Optionally, the network issue information obtaining apparatus according to the third aspect further includes a storage module, and the storage module stores a program or instructions. In response to the processing module executing the program or the instructions, the network issue information obtaining apparatus performs the network issue information obtaining method according to the first aspect.

The network issue information obtaining apparatus according to the third aspect is a vendor network device (for example, a domain management function unit), or is a chip (system) or another component or part that is disposed in the vendor network device, or is an apparatus including the vendor network device. This is not limited in this application.

In addition, for technical effect of the network issue information obtaining apparatus according to the third aspect, refer to the technical effect of the network issue information obtaining method according to the first aspect. Details are not described herein again.

According to a fourth aspect, a network issue information obtaining apparatus is provided. The network issue information obtaining apparatus includes a processing module and a transceiver module. The transceiver module is configured to receive first information about a network issue from a first apparatus. The first information includes one or more of the following: identification information of the network issue, diagnosis information of the network issue, or recovery information of the network issue, the diagnosis information describes an analysis result of the network issue, and the recovery information describes a recovery status of the network issue. The processing module is configured to determine, based on the first information, an operation for processing the network issue.

In at least one embodiment, the network issue includes one or more of the following: a network fault, a network exception, or a network performance indicator exception.

In at least one embodiment, the identification information of the network issue includes one or more of the following: a type of the network issue (issue type), or an object of the network issue (issue object). The type of the network issue includes one or more of the following: coverage, a rate, a capacity, a device fault, service experience, mobility, or energy consumption. The coverage describes a coverage issue of a network, the capacity describes a capacity issue of the network, and the mobility describes a mobility issue of the network. The object of the network issue includes one or more of the following: location information (for example, a geographic grid, a geographic area, or longitude and latitude of a geographic grid), a network element, a cell, or a terminal user.

Optionally, the coverage corresponds to one or more of the following network issues: a coverage rate is less than a first coverage rate threshold, a coverage rate is greater than a second coverage rate threshold, reference signal received power is less than a reference signal received power threshold, a signal to interference plus noise ratio is less than a signal to interference plus noise ratio threshold, or there is no coverage. In addition, the coverage also corresponds to one or more of the following network issues: a coverage vulnerability in a network, a mismatch between uplink and downlink coverage of a network, or pilot contamination in a network. The rate corresponds to one or more of the following network issues: the rate is less than a first rate threshold (for example, an average rate is less than an average rate threshold, or a peak rate is less than a peak rate threshold), a quantity of low-rate users is greater than a first quantity threshold, or a quantity of high-rate users is less than a second quantity threshold. The low-rate user is a user whose rate is less than a second rate threshold, and the high-rate user is a user whose rate is greater than a third rate threshold. The capacity corresponds to one or more of the following network issues: network load is greater than a load threshold, network load is unbalanced, or a network is congested. The device fault corresponds to one or more of the following network issues: a base station fault, a fronthaul fault, an optical interface fault, a clock fault, a cell fault, or a standing wave fault. The service experience corresponds to one or more of the following network issues: a delay is greater than a delay threshold, a delay jitter is greater than a delay jitter threshold, an access success rate is less than an access success rate threshold, a call drop rate is greater than a call drop rate threshold, a packet loss rate is greater than a packet loss rate threshold, or a mean opinion score is less than a mean opinion score threshold. The mean opinion score describes voice or video quality. The mobility corresponds to one or more of the following network issues: a handover success rate is less than a handover success rate threshold, a premature handover rate is greater than a premature handover rate threshold, a delayed handover rate is greater than a delayed handover rate threshold, or a ping-pong handover rate is greater than a ping-pong handover rate threshold. The energy consumption corresponds to one or more of the following network issues: the energy consumption is greater than an energy consumption threshold, or a traffic volume is low but the energy consumption is high (for example, a traffic volume is lower than a traffic volume threshold but energy consumption is greater than an energy consumption threshold).

In at least one embodiment, the diagnosis information of the network issue includes one or more of the following: a cause of the network issue, a recovery capability corresponding to the network issue, a recovery suggestion for the network issue, or a predicted recovery result of the network issue. The recovery capability corresponding to the network issue includes: the first apparatus recovers the network issue or the first apparatus is not able to recover the network issue. The recovery suggestion for the network issue includes an operation of the first apparatus to recover the network issue. The predicted recovery result of the network issue includes a predicted network performance indicator obtained after the network issue is recovered.

In at least one embodiment, the recovery information of the network issue includes one or more of the following: a recovery status of the network issue, or a recovery result of the network issue. The recovery status of the network issue includes not recovered or being recovered, and the recovery result of the network issue includes successfully recovered, or failed to be recovered. In other words, the recovery information of the network issue includes one or more of the following: not recovered, being recovered, successfully recovered, or failed to be recovered.

In at least one embodiment, the transceiver module is further configured to send a first request to the first apparatus. The first request includes one or more of the following: a network issue query condition or network issue indication information. The network issue query condition is used to indicate the first apparatus to feed back the first information that meets the network issue query condition. The network issue indication information indicates the first apparatus to feed back one or more of the following: the identification information of the network issue, the diagnosis information of the network issue, or the recovery information of the network issue.

In at least one embodiment, the transceiver module is further configured to send a second request to the first apparatus. The second request carries a network issue subscription condition, and the network issue subscription condition is used to indicate that the first apparatus feeds back the first information in response to the first information that meets the network issue subscription condition being generated or updated.

Optionally, a sending module and a receiving module is integrated into one module, for example, a transceiver module. The receiving module is configured to implement a receiving function of the network issue information obtaining apparatus according to the fourth aspect, and the sending module is configured to implement a sending function of the network issue information obtaining apparatus according to the fourth aspect.

Optionally, the network issue information obtaining apparatus according to the fourth aspect further includes a storage module, and the storage module stores a program or instructions. In response to the processing module executing the program or the instructions, the network issue information obtaining apparatus performs the network issue information obtaining method according to the second aspect.

The network issue information obtaining apparatus according to the fourth aspect is an operator network device (for example, a cross domain management function unit), or is a chip (system) or another component or part that is disposed in the operator network device, or is an apparatus including the operator network device. This is not limited tin embodiments described herein.

In addition, for technical effect of the network issue information obtaining apparatus according to the fourth aspect, refer to the technical effect of the network issue information obtaining method according to the second aspect. Details are not described herein again.

According to a fifth aspect, a network issue information obtaining apparatus is provided. The network issue information obtaining apparatus is configured to perform the network issue information obtaining method according to any one of the implementations of the first aspect or the second aspect.

In at least one embodiment, the network issue information obtaining apparatus according to the fifth aspect is the vendor network device according to the first aspect or the operator network device according to the second aspect, or a chip (system) or another component or part that is disposed in the vendor network device or the operator network device, or an apparatus including the vendor network device or the operator network device.

The network issue information obtaining apparatus according to the fifth aspect includes a corresponding module, a unit, or a means (means) for implementing the network issue information obtaining method according to the first aspect or the second aspect. The module, the unit, or the means is implemented by hardware, or implemented by software, or implemented by hardware executing corresponding software. The hardware or software includes one or more modules or units configured to perform functions related to the network issue information obtaining method.

In addition, for technical effect of the network issue information obtaining apparatus according to the fifth aspect, refer to the technical effect of the network issue information obtaining method according to the first aspect or the second aspect. Details are not described herein again.

According to a sixth aspect, a network issue information obtaining apparatus is provided. The network issue information obtaining apparatus includes a processor, where the processor is configured to perform the network issue information obtaining method according to any one of the implementations of the first aspect or the second aspect.

In at least one embodiment, the network issue information obtaining apparatus according to the sixth aspect further includes a transceiver. The transceiver is a transceiver circuit or an interface circuit. The transceiver is used in communication between the network issue information obtaining apparatus according to the sixth aspect and another network issue information obtaining apparatus.

In at least one embodiment, the network issue information obtaining apparatus according to the sixth aspect further includes a memory. The memory and the processor is integrated together, or is disposed separately. The memory is configured to store a computer program and/or data related to the network issue information obtaining method according to any one of the first aspect or the second aspect.

In at least one embodiment, the network issue information obtaining apparatus according to the sixth aspect is the vendor network device according to the first aspect or the operator network device according to the second aspect, or a chip (system) or another component or part that is disposed in the vendor network device or the operator network device, or an apparatus including the vendor network device or the operator network device.

In addition, for technical effect of the network issue information obtaining apparatus according to the sixth aspect, refer to the technical effect of the network issue information obtaining method according to any one of the implementations of the first aspect or the second aspect. Details are not described herein again.

According to a seventh aspect, a network issue information obtaining apparatus is provided. The network issue information obtaining apparatus includes a processor. The processor is coupled to a memory, and the processor is configured to execute a computer program stored in the memory, so that the network issue information obtaining apparatus performs the network issue information obtaining method according to any one of the implementations of the first aspect or the second aspect.

In at least one embodiment, the network issue information obtaining apparatus according to the seventh aspect further includes a transceiver. The transceiver is a transceiver circuit or an interface circuit. The transceiver is used in communication between the network issue information obtaining apparatus according to the eighth aspect and another network issue information obtaining apparatus.

In at least one embodiment, the network issue information obtaining apparatus according to the eighth aspect is the vendor network device according to the first aspect or the operator network device according to the second aspect, or a chip (system) or another component or part that is disposed in the vendor network device or the operator network device, or an apparatus including the vendor network device or the operator network device.

In addition, for technical effect of the network issue information obtaining apparatus according to the eighth aspect, refer to the technical effect of the network issue information obtaining method according to any one of the implementations of the first aspect or the second aspect. Details are not described herein again.

According to an eighth aspect, a network issue information obtaining apparatus is provided, including a processor and a memory. The memory is configured to store a computer program. In response to the processor executing the computer program, the network issue information obtaining apparatus performs the network issue information obtaining method according to any one of the implementations of the first aspect or the second aspect.

In at least one embodiment, the network issue information obtaining apparatus according to the eighth aspect further includes a transceiver. The transceiver is a transceiver circuit or an interface circuit. The transceiver is used in communication between the network issue information obtaining apparatus according to the eighth aspect and another network issue information obtaining apparatus.

In at least one embodiment, the network issue information obtaining apparatus according to the eighth aspect is the vendor network device according to the first aspect or the operator network device according to the second aspect, or a chip (system) or another component or part that is disposed in the vendor network device or the operator network device, or an apparatus including the vendor network device or the operator network device.

In addition, for technical effect of the network issue information obtaining apparatus according to the eighth aspect, refer to the technical effect of the network issue information obtaining method according to any one of the implementations of the first aspect or the second aspect. Details are not described herein again.

According to a ninth aspect, a network issue information obtaining apparatus is provided, including a processor. The processor is configured to: after being coupled to a memory and reading a computer program in the memory, perform, based on the computer program, the network issue information obtaining method according to any one of the implementations of the first aspect or the second aspect.

In at least one embodiment, the network issue information obtaining apparatus according to the ninth aspect further includes a transceiver. The transceiver is a transceiver circuit or an interface circuit. The transceiver is used in communication between the network issue information obtaining apparatus according to the ninth aspect and another network issue information obtaining apparatus.

In at least one embodiment, the network issue information obtaining apparatus according to the ninth aspect is the vendor network device according to the first aspect or the operator network device according to the second aspect, or a chip (system) or another component or part that is disposed in the vendor network device or the operator network device, or an apparatus including the vendor network device or the operator network device.

In addition, for technical effect of the network issue information obtaining apparatus according to the ninth aspect, refer to the technical effect of the network issue information obtaining method according to any one of the implementations of the first aspect or the second aspect. Details are not described herein again.

According to a tenth aspect, a processor is provided. The processor is configured to perform the network issue information obtaining method according to any one of the implementations of the first aspect or the second aspect.

According to an eleventh aspect, a communication system is provided. The communication system includes a first apparatus and a second apparatus, and the first apparatus is connected to the second apparatus. The first apparatus is configured to perform the network issue information obtaining method according to the first aspect. The second apparatus is configured to perform the network issue information obtaining method according to the second aspect.

In addition, for technical effect of the communication system according to the eleventh aspect, refer to the technical effect of the network issue information obtaining methods according to the first aspect and the second aspect. Details are not described herein again.

According to a twelfth aspect, a communication method is provided. The communication method is applied to a communication system, the communication system includes a first apparatus and a second apparatus, and the first apparatus is connected to the second apparatus. The communication method includes: The first apparatus determines first information about a network issue, and sends the first information to the second apparatus. The first information includes one or more of the following: identification information of the network issue, diagnosis information of the network issue, or recovery information of the network issue, the diagnosis information describes an analysis result of the network issue, and the recovery information describes a recovery status of the network issue. The second apparatus receives the first information about the network issue from the first apparatus, and determines, based on the first information, an operation for processing the network issue.

In at least one embodiment, the network issue includes one or more of the following: a network fault, a network exception, or a network performance indicator exception.

In at least one embodiment, the identification information of the network issue includes one or more of the following: a type of the network issue, or an object of the network issue. The type of the network issue includes one or more of the following: coverage, a rate, a capacity, a device fault, service experience, mobility, or energy consumption. The coverage describes a coverage issue of a network, the capacity describes a capacity issue of the network, and the mobility describes a mobility issue of the network. The object of the network issue includes one or more of the following: location information (for example, a geographic grid, a geographic area, or longitude and latitude of a geographic grid), a network element, a cell, or a terminal user.

Optionally, the coverage corresponds to one or more of the following network issues: a coverage rate is less than a first coverage rate threshold, a coverage rate is greater than a second coverage rate threshold, reference signal received power is less than a reference signal received power threshold, a signal to interference plus noise ratio is less than a signal to interference plus noise ratio threshold, or there is no coverage. In addition, the coverage also corresponds to one or more of the following network issues: a coverage vulnerability in a network, a mismatch between uplink and downlink coverage of a network, or pilot contamination in a network. The rate corresponds to one or more of the following network issues: the rate is less than a first rate threshold (for example, an average rate is less than an average rate threshold, or a peak rate is less than a peak rate threshold), a quantity of low-rate users is greater than a first quantity threshold, or a quantity of high-rate users is less than a second quantity threshold. The low-rate user is a user whose rate is less than a second rate threshold, and the high-rate user is a user whose rate is greater than a third rate threshold. The capacity corresponds to one or more of the following network issues: network load is greater than a load threshold, network load is unbalanced, or a network is congested. The device fault corresponds to one or more of the following network issues: a base station fault, a fronthaul fault, an optical interface fault, a clock fault, a cell fault, or a standing wave fault. The service experience corresponds to one or more of the following network issues: a delay is greater than a delay threshold, a delay jitter is greater than a delay jitter threshold, an access success rate is less than an access success rate threshold, a call drop rate is greater than a call drop rate threshold, a packet loss rate is greater than a packet loss rate threshold, or a mean opinion score is less than a mean opinion score threshold. The mean opinion score describes voice or video quality. The mobility corresponds to one or more of the following network issues: a handover success rate is less than a handover success rate threshold, a premature handover rate is greater than a premature handover rate threshold, a delayed handover rate is greater than a delayed handover rate threshold, or a ping-pong handover rate is greater than a ping-pong handover rate threshold. The energy consumption corresponds to one or more of the following network issues: the energy consumption is greater than an energy consumption threshold, or a traffic volume is low but the energy consumption is high (for example, a traffic volume is lower than a traffic volume threshold but the energy consumption is greater than an energy consumption threshold).

In at least one embodiment, the diagnosis information of the network issue includes one or more of the following: a cause of the network issue, a recovery capability corresponding to the network issue, a recovery suggestion for the network issue, or a predicted recovery result of the network issue. The recovery capability corresponding to the network issue includes: the first apparatus recovers the network issue or the first apparatus is not able to recover the network issue. The recovery suggestion for the network issue includes an operation of the first apparatus to recover the network issue. The predicted recovery result of the network issue includes a predicted network performance indicator obtained after the network issue is recovered.

In at least one embodiment, the recovery information of the network issue includes one or more of the following: a recovery status of the network issue, or a recovery result of the network issue. The recovery status of the network issue includes not recovered or being recovered, and the recovery result of the network issue includes successfully recovered, or failed to be recovered. In other words, the recovery information of the network issue includes one or more of the following: not recovered, being recovered, successfully recovered, or failed to be recovered.

In at least one embodiment, the communication method according to the twelfth aspect further includes: The second apparatus sends a first request to the first apparatus. The first request includes one or more of the following: a network issue query condition or network issue indication information. The network issue query condition is used to indicate the first apparatus to feed back the first information that meets the network issue query condition. The network issue indication information indicates the first apparatus to feed back one or more of the following: the identification information of the network issue, the diagnosis information of the network issue, or the recovery information of the network issue. The first apparatus receives the first request from the second apparatus.

In at least one embodiment, the communication method according to the twelfth aspect further includes: The second apparatus sends a second request to the first apparatus. The second request carries a network issue subscription condition, and the network issue subscription condition is used to indicate that the first apparatus feeds back the first information in response to the first information that meets the network issue subscription condition being generated or updated. The first apparatus receives the second request from the second apparatus.

In addition, for technical effect of the communication method according to the twelfth aspect, refer to the technical effect of the network issue information obtaining methods according to the first aspect and the second aspect. Details are not described herein again.

According to a thirteenth aspect, a computer-readable storage medium is provided, including a computer program or instructions. In response to the computer program or instructions being run on a computer, the computer is enabled to perform the network issue information obtaining method according to any one of the implementations of the first aspect or the second aspect.

According to a fourteenth aspect, a computer program product is provided, including a computer program or instructions. In response to the computer program or the instructions being run on a computer, the computer is enabled to perform the network issue information obtaining method according to any one of the implementations of the first aspect or the second aspect.

### BRIEF DESCRIPTION OF DRAWINGS

FIG. 1 is a schematic diagram 1 of an architecture of a communication system according to at least one embodiment;

FIG. 2 shows an example of the communication system shown in FIG. 1;

FIG. 3 is a schematic flowchart of a network issue information obtaining method according to at least one embodiment;

FIG. 4 is a schematic diagram 1 of reporting first information about a network issue according to at least one embodiment;

FIG. 5 is a schematic diagram 2 of reporting first information about a network issue according to at least one embodiment;

FIG. 6 is a schematic diagram 3 of reporting first information about a network issue according to at least one embodiment;

FIG. 7 is a schematic diagram 4 of reporting first information about a network issue according to at least one embodiment;

FIG. 8 is a schematic diagram 5 of reporting first information about a network issue according to at least one embodiment;

FIG. 9 is a schematic diagram 1 of a structure of a network issue information obtaining apparatus according to at least one embodiment; and

FIG. 10 is a schematic diagram 2 of a structure of a network issue information obtaining apparatus according to at least one embodiment.

### DESCRIPTION OF EMBODIMENTS

For ease of understanding solutions in embodiments described herein, related concepts are first briefly described as follows.

1. Service Operation Unit

A service operation unit is also referred to as a communication service management function (communication service management function) unit, and provides functions or management services such as charging, settlement, accounting, a customer service, business, network monitoring, communication service life cycle management, and service intent translation. For example, the service operation unit is a unit in an operator operation system or a vertical service operation system (vertical service operation system).

2. Cross Domain Management Function Unit

A cross domain management function unit is also referred to as a network management function (network management function, NMF) unit. The cross domain management function unit provides one or more of the following functions or management services: life cycle management of a network, deployment of a network, fault management of a network, performance management of a network, configuration management of a network, assurance of a network, optimization of a network, translation of intent from communication service provider (intent from communication service provider, intent-CSP), translation of intent from communication service consumer (intent from communication service consumer, intent-CSC), or the like. The network herein includes one or more of the following: one or more network elements (network elements, NEs), one or more sub-networks, or one or more network slices.

For example, the cross domain management function unit is any one of the following: a network slice management function (network slice management function, NSMF) unit, a management data analytic function (management data analytic function, MDAF) unit, a cross domain self-organization network function (self-organization network function, SON-function) unit, or a cross domain intent management function unit.

In some deployment scenarios, the cross domain management function unit also provides one or more of the following functions or management services: life cycle management of a sub-network, deployment of a sub-network, fault management of a sub-network, performance management of a sub-network, configuration management of a sub-network, assurance of a sub-network, optimization of a sub-network, or translation of intent from a sub-network. The sub-network herein includes a plurality of small sub-networks or a plurality of network slice subnets. For example, one access network sub-network of an operator includes an access network sub-network of a vendor 1 and an access network sub-network of a vendor 2.

3. Domain Management Function Unit

A domain management function unit is also referred to as a sub-network management function (sub-network management function, NMF) unit, or is referred to as a network element management function (network element management function) unit. The domain management function unit provides one or more of the following functions or management services: life cycle management of a sub-network or network element, deployment of a sub-network or network element, fault management of a sub-network or network element, performance management of a sub-network or network element, assurance of a sub-network or network element, optimization management of a sub-network or network element, translation of intent from a sub-network or network element, or the like. The sub-network herein includes one or more network elements; or the sub-network herein also includes one or more sub-networks, that is, one or more sub-networks form a sub-network with a larger coverage area; or the sub-network herein includes one or more network slice subnets.

For example, the sub-network is described in the following manners:
Manner 1: A network in a technical domain, for example, a radio access network, a core network, or a transmission network.
Manner 2: A network of a standard, for example, a global system for mobile communications (global system for mobile communications, GSM) network, a long term evolution (long term evolution, LTE) network, or a 5^{th} generation (5^{th} generation, 5G) mobile communication system network.
Manner 3: A network provided by a vendor, for example, a network provided by a vendor 1.
Manner 4: A network in a geographical area, for example, a network of a factory A, or a network of a prefecture-level city B.

4. Network Element

A network element is an entity that provides a network service, including a core network element, an access network element, and the like. For example, the core network element includes but is not limited to an access and mobility management function (access and mobility management function, AMF) entity, a session management function (session management function, SMF) entity, a policy control function (policy control function, PCF) entity, a network data analysis function (network data analysis function, NWDAF) entity, a network repository function (network repository function, NRF), a gateway, and the like. The access network element includes but is not limited to various base stations (for example, a next generation NodeB (generation NodeB, gNB) and an evolved NodeB (evolved NodeB, eNB)), a central unit control panel (central unit control panel, CUCP), a central unit (central unit, CU), a distributed unit (distributed unit, DU), a central unit user panel (central unit user panel, CUUP), or the like.

In addition, in at least one embodiment, a network function (network function, NF) is also referred to as a network element.

5. Service-Based Management Architecture (Service-Based Management Architecture, SBMA)

A service-based management architecture is a basic architecture of a 5G network, and divides network functions into several “service” modules that is flexibly invoked. “Services” communicate with each other through interfaces, so that a communication system is efficient, software-based, and open. Based on the service-based management architecture, an operator is able to flexibly customize networking based on a service usage.

The following describes the technical solutions of at least one embodiment, with reference to accompanying drawings.

The technical solutions in at least one embodiment is applied to various communication systems, for example, a wireless fidelity (wireless fidelity, Wi-Fi) system, a vehicle to everything (vehicle-to-everything, V2X) communication system, a device-to-device (device-to-device, D2D) communication system, an internet of vehicles communication system, a 4^{th} generation (4^{th} generation, 4G) mobile communication system such as a long term evolution system or a worldwide interoperability for microwave access (worldwide interoperability for microwave access, WiMAX) communication system, a 5^{th} generation mobile communication systems such as a new radio (new radio, NR) system, and a future communication system such as a 6^{th} generation (6^{th} generation, 6G) mobile communication system.

All aspects, embodiments, or features are presented in this application by describing a system that includes a plurality of devices, components, modules, and the like. Each system includes another device, component, module, and the like, and/or does not include all devices, components, modules, and the like discussed with reference to the accompanying drawings. In addition, a combination of these solutions is used.

In addition, in at least one embodiment, terms such as “example” and “for example” are used to represent giving an example, an illustration, or a description. Any embodiment or design scheme described as an “example” in this application should not be explained as being more preferable or having more advantages than another embodiment or design scheme. Exactly, the term “example” is used to present a concept in a specific manner.

In at least one embodiment, terms “information (information)”, “signal (signal)”, “message (message)”, “channel (channel)”, and “signaling (signaling)” is sometimes interchangeably used. Meanings expressed by the terms are consistent in response to differences of the terms not being emphasized. The terms “of (of)”, “corresponding (corresponding, relevant)”, and “corresponding (corresponding)” is interchangeably used sometimes. Meanings expressed by the terms are consistent in response to differences of the terms not being emphasized.

In at least one embodiment, sometimes a subscript, for example, W₁, is written incorrectly in a non-subscript form, for example, W1. Expressed meanings are consistent in response to differences not being emphasized.

A network architecture and a service scenario described in at least one embodiment are intended to describe the technical solutions in at least one embodiment more clearly, and do not constitute a limitation on the technical solutions provided in at least one embodiment. A person of ordinary skill in the art know that: With the evolution of the network architecture and the emergence of new service scenarios, the technical solutions provided in at least one embodiment are also applicable to similar technical issues.

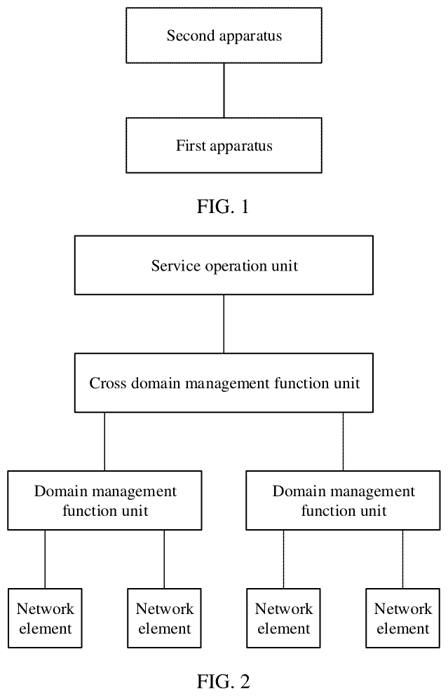

For ease of understanding at least one embodiment, a communication system shown in FIG. 1 is first used as an example to describe in detail a communication system to which embodiments described herein are applicable. For example, FIG. 1 is a schematic diagram 1 of an architecture of a communication system to which a network issue information obtaining method according to at least one embodiment is applicable.

As shown in FIG. 1, the communication system includes a first apparatus and a second apparatus. The first apparatus is connected to the second apparatus, and the second apparatus sends a network target to the first apparatus. For example, the network target includes: An average rate of a network is greater than 10 megabits per second (megabits per second, Mbps), a weak coverage ratio is less than 5%, or a quantity of users whose rate is lower than 5 Mbps accounts for less than 5% of a total quantity of users. The first apparatus receives the network target, and resolve a network issue based on the network target. For example, the first apparatus monitors the network, identify the network issue in the network, and diagnose and recover the network issue, so that performance of the network meets the network target, thereby maintaining the network. In other words, the first apparatus provides a network management service for the second apparatus. The first apparatus is referred to as a vendor network device, and the second apparatus is referred to as an operator network device.

In at least one embodiment, in the communication system shown in FIG. 1, the first apparatus is configured to determine first information about the network issue, and send the first information to the second apparatus. The first information includes one or more of the following: identification information of the network issue, diagnosis information of the network issue, or recovery information of the network issue, the diagnosis information describes an analysis result of the network issue, and the recovery information describes a recovery status of the network issue. The second apparatus is configured to: receive the first information about the network issue from the first apparatus, and determine, based on the first information, an operation for processing the network issue. Specific implementations and technical effect of the foregoing solutions are described in detail in subsequent method embodiments, and details are not described herein again.

In a service-based management architecture, the second apparatus is referred to as a management service (management service, MnS) consumer (consumer), and the first apparatus is referred to as a management service provider (producer).

For example, FIG. 2 shows an example of the communication system shown in FIG. 1. As shown in FIG. 2, the communication system includes a service operation unit, a cross domain management function unit, domain management function units, and network elements. The service operation unit is connected to one or more cross domain management function units (the example in which the service operation unit is connected to one cross domain management function unit is used in FIG. 2). The cross domain management function unit is connected to one or more domain management function units. The domain management function unit is connected to one or more network elements.

The first apparatus and the first apparatus each is any one of the service operation unit, the cross domain management function unit, the domain management function unit, and the network element. Specifically, in response to the first apparatus being the service operation unit, the second apparatus is another service operation unit. In response to the first apparatus being the cross domain management function unit, the second apparatus is the service operation unit connected to the cross domain management function unit. In response to the first apparatus being the domain management function unit, the second apparatus is the cross domain management function unit, a network data analysis functional entity, or the service operation unit connected to the domain management function unit. In response to the first apparatus being the network element, the second apparatus is the domain management function unit, the cross domain management function unit, a network data analysis functional entity, or the service operation unit connected to the network element. In at least one embodiment, specific devices or apparatuses that the first apparatus and the second apparatus are in a network is not limited.

The network issue information obtaining method provided in at least one embodiment is applicable between the first apparatus and the second apparatus shown in FIG. 1, for example, between the service operation unit and the cross domain management function unit, and between the cross domain management function unit and the domain management function unit, and between the domain management function unit and the network element. For a specific implementation, refer to the following method embodiment, and details are not described herein again.

Embodiments described here are also used in another communication system, and a corresponding name is also replaced with a name of a corresponding function in the another communication system.

FIG. 1 is merely a simplified schematic diagram of an example for ease of understanding. The communication system further includes another network device and/or another terminal device that are/is not shown in FIG. 1.

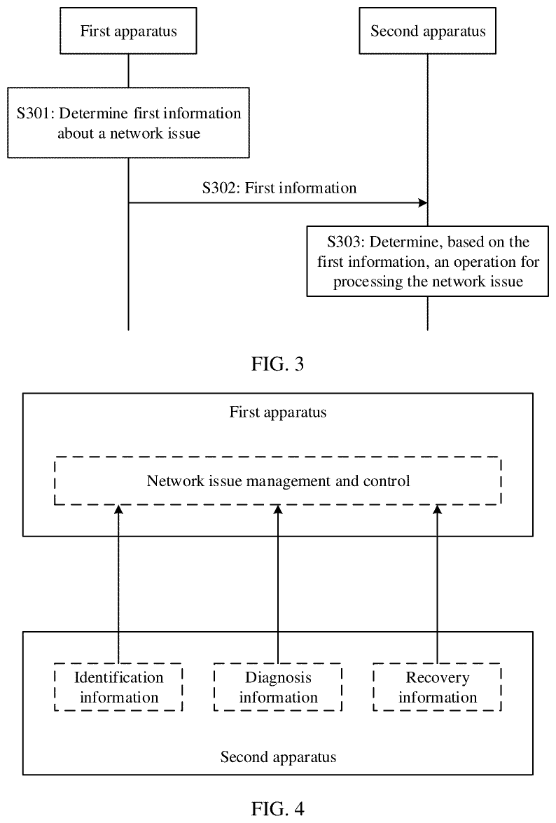

The foregoing describes the communication system provided in at least one embodiment with reference to FIG. 1 and FIG. 2. The following describes in detail the network issue information obtaining method provided in at least one embodiment with reference to FIG. 3 to FIG. 8.

For example, FIG. 3 is a schematic flowchart of a network issue information obtaining method according to at least one embodiment. The network issue information obtaining method is applicable to communication between the first apparatus and the second apparatus shown in FIG. 1.

As shown in FIG. 3, the network issue information obtaining method includes the following steps.

S301: The first apparatus determines first information about a network issue.

The network issue includes one or more of the following: a network fault, a network exception, or a network performance indicator exception.

For example, the network fault includes a base station fault, a fronthaul fault, an optical interface fault, or the like. The network exception includes a long network delay, a high call drop rate, a low rate, or the like. The network performance indicator exception includes: A weak coverage ratio is greater than 5%, a quantity of users whose rate is lower than 5 Mbps accounts for more than 5% of a total quantity of users, or the like.

Based on the foregoing descriptions about the network issue, a case in which a parameter (for example, a business parameter, a service parameter, or a user parameter) is not met in a network is referred to as the network issue.

To describe the network issue in the network in detail and accurately, the first information about the network issue includes one or more of the following: identification information of the network issue, diagnosis information of the network issue, or recovery information of the network issue.

A manner of determining the identification information of the network issue includes: The first apparatus monitors the network, to identify the network issue in the network and generate the identification information of the network issue. A manner of determining the diagnosis information of the network issue includes: The first apparatus performs diagnosis analysis on the network issue, and generates the diagnosis information of the network issue, that is, the diagnosis information of the network issue describes an analysis result of the network issue. A manner of determining the recovery information of the network issue includes: The first apparatus recovers the network issue, and generates the recovery information of the network issue, that is, the recovery information of the network issue describes a recovery status of the network issue.

To describe the identification information of the network issue in detail and accurately, in at least one embodiment, the identification information of the network issue includes one or more of the following: a type of the network issue, a name of the network issue, or an object of the network issue.

The type of the network issue includes one or more of the following: coverage, a rate, a capacity, a device fault, service experience, mobility, or energy consumption. The coverage describes an issue in network coverage, such as weak coverage and a mismatch between uplink and downlink coverage. The rate describes an issue in a network rate, such as a low average rate and a low peak rate. The capacity describes an issue in a network capacity, for example, network load is unbalanced and the network is congested. The service experience describes an issue in network service experience, such as a long delay and a large delay jitter. The mobility describes an issue in network mobility, such as a frequent ping-pong handover and a high call drop rate. The energy consumption describes an issue in network energy consumption, such as high energy consumption. The device fault describes a fault in a network device, for example, a base station 1 is faulty. The object of the network issue includes one or more of the following: location information (for example, a geographic grid, a geographic area, or longitude and latitude of a geographic grid), a network element, a cell, or a terminal user.

Optionally, in response to the type of the network issue being the coverage, the name of the network issue includes one or more of the following: A coverage rate is less than a first coverage rate threshold, a coverage rate is greater than a second coverage rate threshold, reference signal received power (reference signal received power, RSRP) is less than a reference signal received power threshold, a signal to interference plus noise ratio is less than a signal to interference plus noise ratio threshold, or there is no coverage. In other words, the coverage corresponds to one or more of the following network issues: A coverage rate is less than a first coverage rate threshold, a coverage rate is greater than a second coverage rate threshold, reference signal received power is less than a reference signal received power threshold, a signal to interference plus noise ratio is less than a signal to interference plus noise ratio threshold, or there is no coverage. In addition, the coverage also corresponds to one or more of the following network issues: a coverage vulnerability in the network, a mismatch between uplink and downlink coverage of the network, or pilot contamination in the network. Details are described below.

That the coverage rate is less than the first coverage rate threshold is also referred to as weak coverage, that the coverage rate is greater than the second coverage rate threshold is also referred to as over-coverage, that the reference signal received power is less than the reference signal received power threshold is also referred to as low reference signal received power, and that the signal to interference plus noise ratio is less than the signal to interference plus noise ratio threshold is also referred to as a small signal to interference plus noise ratio.

The pilot contamination is a phenomenon that there are many strong pilots at a receiving location, resulting in a case that some strong pilots are not added to an activated set of a user device (user equipment, UE), and these pilot signals cause severe interference to a valid signal.

In response to the type of the network issue being the rate, the name of the network issue includes one or more of the following: The rate is less than a first rate threshold, a quantity of low-rate users is greater than a first quantity threshold, or a quantity of high-rate users is less than a second quantity threshold. The low-rate user is a user whose rate is less than a second rate threshold, and the high-rate user is a user whose rate is greater than a third rate threshold. In other words, the rate corresponds to one or more of the following network issues: The rate is less than a first rate threshold, a quantity of low-rate users is greater than the first quantity threshold, or a quantity of high-rate users is less than a second quantity threshold. The low-rate user is a user whose rate is less than a second rate threshold, and the high-rate user is a user whose rate is greater than a third rate threshold.

The rate is less than the first rate threshold is also referred to as a low rate, that the quantity of low-rate users is greater than the first quantity threshold is also referred to as a large quantity of low-rate users, and that the quantity of high-rate users is less than the second quantity threshold is also referred to as a small quantity of high-rate users. In addition, the rate herein includes an average rate, or includes a peak rate, or the like. For example, the average rate is less than an average rate threshold, and the peak rate is less than a peak rate threshold.

In response to the type of the network issue being the capacity, the name of the network issue includes one or more of the following: Network load is greater than a load threshold, network load is unbalanced, or the network is congested. In other words, the capacity corresponds to one or more of the following network issues: Network load is greater than a load threshold, network load is unbalanced, or the network is congested.

The network load is greater than the load threshold is also referred to as high load or overload.

In response to the type of the network issue being the device fault, the name of the network issue includes one or more of the following: a base station fault, a fronthaul fault, an optical interface fault (an optical fiber interface fault), a clock fault, a cell fault, or a standing wave fault. In other words, the device fault corresponds to one or more of the following network issues: a base station fault, a fronthaul fault, an optical interface fault, a clock fault, a cell fault, or a standing wave fault.

In response to the type of the network issue being the service experience, the name of the network issue includes one or more of the following: A delay is greater than a delay threshold, a delay jitter is greater than a delay jitter threshold, an access success rate is less than an access success rate threshold, a call drop rate is greater than a call drop rate threshold, or a packet loss rate is greater than a packet loss rate threshold. In other words, the service experience corresponds to one or more of the following network issues: A delay is greater than a delay threshold, a delay jitter is greater than a delay jitter threshold, an access success rate is less than an access success rate threshold, a call drop rate is greater than a call drop rate threshold, a packet loss rate is greater than a packet loss rate threshold, or a mean opinion score is less than a mean opinion score threshold. The mean opinion score describes voice or video quality, and is obtained through quantitative measurement of the voice or video quality.

The delay is greater than the delay threshold is also referred to as a large delay, that the delay jitter is greater than the delay jitter threshold is also referred to as a large delay jitter, that the access success rate is less than the access success rate threshold is also referred to as a low access success rate, that the call drop rate is greater than the call drop rate threshold, and that the packet loss rate is greater than the packet loss rate threshold each is also referred to as a high packet loss rate.

In response to the type of the network issue being the mobility, the name of the network issue includes one or more of the following: A handover success rate is less than a handover success rate threshold, a premature handover rate is greater than a premature handover rate threshold, a delayed handover rate is greater than a delayed handover rate threshold, or a ping-pong handover rate is greater than a ping-pong handover rate threshold. In other words, the mobility corresponds to one or more of the following network issues: A handover success rate is less than a handover success rate threshold, a premature handover rate is greater than a premature handover rate threshold, a delayed handover rate is greater than a delayed handover rate threshold, or a ping-pong handover rate is greater than a ping-pong handover rate threshold.

A premature handover indicates that a radio link failure (radio link failure, RLF) or a handover failure (handover failure, HOF) occurs in a short time in a handover process or after a user device is handed over to a target cell, and then the user device attempts to reestablish a radio link in a source cell. A delayed handover indicates that a radio link failure occurs after a user device camps on a cell for a long time, and then the user device initiates a reestablishment request to another cell. The premature handover rate indicates a ratio of a quantity of premature handovers to a quantity of handover attempts in a unit time period. The delayed handover rate indicates a ratio of a quantity of delayed handovers to a quantity of handover attempts in a unit time period.

The handover success rate is less than the handover success rate threshold is also referred to as a low handover success rate, that the premature handover rate is greater than the premature handover rate threshold is also referred to as a high premature handover rate, that the delayed handover rate is greater than the delayed handover rate threshold is also referred to as a high delayed handover rate, and that the ping-pong handover rate is greater than the ping-pong handover rate threshold is also referred to as a frequent ping-pong handover or a large ping-pong handover rate.

In response to the type of the network issue being the energy consumption, the name of the network issue includes one or more of the following: Energy consumption is greater than an energy consumption threshold, or a traffic volume is low but energy consumption is high (for example, a traffic volume is lower than a traffic volume threshold but energy consumption is greater than an energy consumption threshold). In other words, the energy consumption corresponds to one or more of the following network issues: The energy consumption is greater than an energy consumption threshold, or a traffic volume is low but the energy consumption is high.

The energy consumption is greater than the energy consumption threshold is also referred to as high energy consumption.

Optionally, each piece of identification information of the network issue corresponds to an identifier of the network issue (issue id). In other words, for identification information of a network issue, an identifier is allocated to the identification information of the network issue, so that identification information of different network issues is easily distinguished.

The identification information of the network issue is described below by using an example with reference to Table 1.

Table 1 is a table of identification information of a plurality of network issues determined by the first apparatus. Identification information of the network issue corresponding to an identifier 1 is as follows: A coverage issue exists at a location 1 in the network, and specifically, a coverage rate at the location 1 is less than 75%; identification information of the network issue corresponding to an identifier 2 is as follows: A rate issue exists in a cell 1 in the network, and specifically, a quantity of high-rate users in the cell 1 is less than 35; . . . ; and identification information of the network issue corresponding to an identifier N is as follows: A device fault issue exists in a network element 1, and specifically, a network element 1 is faulty.

TABLE 1

| Identifiers | Identification information of the network issues | | |
|---|---|---|---|
| of the network | Types of the | Names of the | Objects of the |
| issues | network issues | network issues | network issues |
| Identifier 1 | Coverage | The coverage rate is | Location 1 |
| | | less than 75%. | |
| Identifier 2 | Rate | The quantity of | Cell 1 |
| | | high-rate users is | |
| | | less than 35. | |
| . . . | . . . | . . . | . . . |
| Identifier N | Device fault | Base station fault | Network |
| | | | element 1 |

For example, refer to Table 1. The first apparatus sends, to the second apparatus, the identification information of the network issue corresponding to the identifier 2, the second apparatus determines, in real time based on the identification information of the network issue, an operation for processing the network issue, for example, determines to adjust a configuration parameter of the cell 1, so as to resolve the rate issue in the cell 1. In other words, the identification information of the network issue is classified in detail, so that the identification information of the network issue is more accurate and detailed. The second apparatus device obtains the detailed identification information of the network issue in real time, and accurately locate the network issue, thereby improving precision of identifying the network issue by the operator network device. In addition, the operation for processing the network issue is targetedly determined. This accurately and effectively resolves the network issue in the network, and improve network operation&maintenance efficiency.

Optionally, the identification information of the network issues is implemented by using data structures in Table 2 and Table 3. Specifically, Table 2 is a table of objects of the network issues (information object class, IOC), and includes the following pieces of data: an attribute name (attribute name), whether readable (is readable), and whether writable (is writable). The attribute name in Table 2 includes the identification information of the network issues and the identifiers of the network issues. The identification information of the network issues is a pointer pointing to Table 3.

Table 3 is a data type (data type) table, and includes the following pieces of data: an attribute name, whether readable, and whether writable. The attribute name in Table 3 includes the types of the network issues, the names of the network issues, or the objects of the network issues.

In other words, the identification information of the network issues is generated based on the data structures shown in Table 2 and Table 3.

TABLE 2

| | Whether | Whether |
|---|---|---|
| Attribute name | readable | writable |
| Identifiers of the network issues | Yes (true) | No (false) |
| Identification information of the network | Yes | No |
| issues (pointing to Table 3) | | |

TABLE 3

| Attribute name | Whether readable | Whether writable |
|---|---|---|
| Types of the network issues | Yes | No |
| Names of the network issues | Yes | No |
| Objects of the network issues | Yes | No |

Optionally, the identification information of the network issue is included in a network issue discovery notification. In addition, the network issue discovery notification includes a managed object added notification or a network issue added notification.

To describe the diagnosis information of the network issue in detail and accurately, in at least one embodiment, the diagnosis information of the network issue includes one or more of the following: a cause of the network issue, a recovery capability corresponding to the network issue, a recovery suggestion for the network issue, or a predicted recovery result of the network issue.

The cause of the network issue includes an inappropriate cell parameter configuration, for example, an inappropriate massive (massive) multiple input multiple output (massive multiple input multiple output, MIMO) pattern (pattern) parameter configuration, interference between cells, apparatus damage (for example, a base station damage), and the like. The recovery capability corresponding to the network issue includes: The first apparatus recovers the network issue or the first apparatus is not able to recover the network issue. The recovery suggestion for the network issue includes an operation of the first apparatus to recover the network issue. The predicted recovery result of the network issue includes a predicted network performance indicator obtained after the network issue is recovered.

In addition, the cause of the network issue is also referred to as a root cause of the network issue, a reason of the network issue, a root reason of the network issue, or a root of the network issue. The network issue that the first apparatus recovers is referred to as recoverable, and the network issue that the first apparatus is not able to recover is referred to as unrecoverable.

The diagnosis information of the network issue is described below by using an example with reference to Table 4.

Table 4 is a table of diagnosis information of the plurality of network issues determined by the first apparatus. Diagnosis information of the network issue corresponding to an identifier 1 is as follows: A cause of the network issue is an inappropriate parameter configuration, the network issue is recoverable, a recovery suggestion includes a recommended parameter configuration set, and a predicted recovery result is that a coverage rate is greater than 80%; diagnosis information of the network issue corresponding to an identifier 2 is as follows: A cause of the network issue is interference between cells, the network issue is recoverable, the recovery suggestion includes a recommended cell parameter, and a predicted recovery result is that a quantity of high-rate users is greater than 50; . . . ; and diagnosis information of the network issue corresponding to an identifier N is as follows: A cause of the network issue is apparatus damage, the network issue is recoverable, a recovery suggestion is replacing a network element 1, and a predicted recovery result is that the network element 1 is successfully recovered.

For example, refer to Table 4. The first apparatus sends, to the second apparatus, the diagnosis information of the network issue corresponding to the identifier 2, the second apparatus determines, in real time based on the diagnosis information of the network issue, an operation for processing the network issue. For example, the first apparatus is indicated to configure a cell based on the recommended cell parameter, so as to resolve the network issue. In other words, the diagnosis information of the network issue is classified in detail, so that the diagnosis information of the network issue is more accurate and detailed. The second apparatus device obtains the detailed diagnosis information of the network issue in real time, and accurately locate the network issue, thereby improving precision of identifying the network issue by the operator network device. In addition, the operation for processing the network issue is targetedly determined. This accurately and effectively resolves the network issue in the network, and improves network operation&maintenance efficiency.

TABLE 4

| | Diagnosis information of the network issues | | | |
|---|---|---|---|---|
| | | | | Predicted |
| Identifiers of | Causes of the | Recovery capacities | Recovery | recovery results |
| the network | network | corresponding to the | suggestions for the | of the network |
| issues | issues | network issues | network issues | issues |
| Identifier 1 | Inappropriate | Recoverable | Recommended | A coverage rate is |
| | parameter | | parameter | greater than 80%. |
| | configuration | | configuration set | |
| Identifier 2 | Interference | Recoverable | Recommended | A quantity of |
| | between cells | | cell parameter | high-rate users is |
| | | | | greater than 50. |
| . . . | . . . | . . . | . . . | . . . |
| Identifier N | Apparatus | Recoverable | Replacing a | The network |
| | damage | | network element 1 | element 1 is |
| | | | | successfully |
| | | | | recovered. |

Optionally, the diagnosis information of the network issues is implemented by using data structures in Table 5 and Table 6. Specifically, Table 5 is a table of objects of the network issues, and includes the following pieces of data: an attribute name, whether readable, and whether writable. The attribute name in Table 5 includes the diagnosis information of the network issues and the identifiers of the network issues. The diagnosis information of the network issues is a pointer pointing to Table 6.

Table 6 is a data type table, and includes the following pieces of data: an attribute name, whether readable, and whether writable. The attribute name in Table 6 includes the causes of the network issues, the recovery capabilities corresponding to the network issues, the recovery suggestions for the network issue, and the predicted recovery results of the network issues.

In other words, the diagnosis information of the network issues is generated based on the data structures shown in Table 5 and Table 6.

TABLE 5

| | Whether | Whether |
|---|---|---|
| Attribute name | readable | writable |
| Identifiers of the network issues | Yes | No |
| Diagnosis information of the network issues | Yes | No |
| (pointing to Table 6) | | |

TABLE 6

| | Whether | Whether |
|---|---|---|
| Attribute name | readable | writable |
| Causes of the network issues | Yes | No |
| Recovery capacities corresponding to the | Yes | No |
| network issues | | |
| Recovery suggestions for the network issues | Yes | No |
| Predicted recovery results of the network issues | Yes | No |

Optionally, the diagnosis information of the network issue is included in a network issue diagnosis notification. In addition, the network issue diagnosis notification includes a network issue update notification or a managed object attribute value change notification.

To describe the recovery information of the network issue in detail and accurately, in some embodiments, the recovery information of the network issue includes one or more of the following: a recovery status of the network issue or a recovery result of the network issue. The recovery status of the network issue includes not recovered or being recovered, and the recovery result of the network issue includes successfully recovered, or failed to be recovered. In other words, the recovery information of the network issue includes one or more of the following: not recovered, being recovered, successfully recovered, or failed to be recovered.

The recovery information of the network issue is also referred to as network issue recovery information.

The recovery information of the network issue is described below by using an example with reference to Table 7.

Table 7 is a table of recovery information of the plurality of network issues determined by the first apparatus. Recovery information of the network issue corresponding to an identifier 1 is being recovered; diagnosis information of the network issue corresponding to an identifier 2 is not recovered; . . . ; and diagnosis information of the network issue corresponding to an identifier N is successfully recovered.

For example, refer to Table 7. The first apparatus sends, to the second apparatus, the recovery information of the network issue corresponding to the identifier 2, the second apparatus determines, in real time based on the recovery information of the network issue, an operation for processing the network issue, for example, periodically queries a recovery progress of the network issue, so as to targetedly resolve the network issue. In other words, the recovery information of the network issue is classified in detail, so that the recovery information of the network issue is more accurate and detailed. The second apparatus obtains the detailed recovery information of the network issue in real time, and accurately locate the network issue, thereby improving precision of identifying the network issue by the operator network device. In addition, the operation for processing the network issue is targetedly determined, so that the network issue in the network is accurately and effectively resolved, and network operation&maintenance efficiency is improved.

TABLE 7

| Identifiers of the network | Recovery information of the network |
|---|---|
| issues | issues |
| Identifier 1 | Being recovered |
| Identifiers of the network | Recovery information of the network |
| issues | issues |
| Identifier 2 | Not recovered |
| . . . | . . . |
| Identifier N | Successfully recovered |

Optionally, the diagnosis information of the network issues is implemented by using data structures in Table 8 and Table 9. Specifically, Table 8 is a table of objects of the network issues, and includes the following pieces of data: an attribute name, whether readable, and whether writable. The attribute name in Table 8 includes recovery information of the network issues and identifiers of the network issues. The recovery information of the network issues is a pointer pointing to Table 9.

Table 9 is a data type table, and includes the following pieces of data: an attribute name, whether readable, and whether writable. The attribute name in Table 9 includes recovery statuses of the network issues and recovery results of the network issues.

In other words, the recovery information of the network issues is generated based on the data structures shown in Table 8 and Table 9.

TABLE 8

| | Whether | Whether |
|---|---|---|
| Attribute name | readable | writable |
| Identifiers of the network issues | Yes | No |
| Recovery information of the network issues | Yes | No |
| (pointing to Table 9) | | |

TABLE 9

| | Whether | Whether |
|---|---|---|
| Attribute name | readable | writable |
| Recovery statuses of the network issues | Yes | No |
| Recovery results of the network issues | Yes | No |

Optionally, the recovery information of the network issue is included in a network issue recovery notification. In addition, the network issue recovery notification includes a network issue update notification or a managed object attribute value change notification.

To enable the second apparatus to obtain a specified network issue in time, in at least one embodiment, before the first apparatus determines first information about a network issue in S301, the network issue information obtaining method shown in FIG. 3 further includes the following steps:

Step 1: The second apparatus sends a first request to the first apparatus, and the first apparatus receives the first request from the second apparatus.

The first request includes one or more of the following: a network issue query condition or network issue indication information.

The network issue query condition is used to indicate the first apparatus to feed back the first information that meets the network issue query condition. For example, refer to Table 4. The network issue query condition is used to indicate to feed back first information about a recoverable network issue, the first apparatus sends, to the second apparatus, the identification information of the network issue, the diagnosis information of the network issue, and the recovery information of the network issue that correspond to the identifier 1.

Based on the foregoing description of the network issue query condition, the network issue query condition includes specified query information. The specified query information includes one or more of various types of information included in the first information about the network issue. For example, the specified query information includes recoverable, the coverage, the rate, and the like; or the specified query information includes the object (such as the location information) of the network issue.

The network issue indication information indicates the first apparatus to feed back one or more of the following: the identification information of the network issue, the diagnosis information of the network issue, or the recovery information of the network issue. For example, the network issue indication information indicates to feed back the identification information of the network issue and the diagnosis information of the network issue, the first apparatus sends the identification information of the network issue and the diagnosis information of the network issue, and feed back information about the specified network issue to the second apparatus in time.

From the foregoing description of step 1, the second apparatus obtains the specified network issue in time by sending the first request to the vendor network device. This manages, controls, and resolves the specified network issue and improve network operation&maintenance efficiency.

The first request implements a query (query) function, and is also referred to as a query request.

To enable the second apparatus to continuously obtain a specified and latest network issue, in at least one embodiment, before the first apparatus determines first information about a network issue in S301, the network issue information obtaining method shown in FIG. 3 further includes the following steps:

Step 2: The second apparatus sends a second request to the first apparatus, and the first apparatus receives the second request from the second apparatus.

The second request carries a network issue subscription condition, and the network issue subscription condition is used to indicate that the first apparatus feeds back the first information in response to the first information that meets the network issue subscription condition is generated or updated.

For example, the network issue subscription condition is used to indicate that the first apparatus feeds back the first information in response to the first information about the recoverable network issue being generated or updated. In other words, the second request is sent to the first apparatus, so that the first apparatus is enabled to continuously send the first information about the specified and latest network issue to the second apparatus.

Based on the foregoing description of the network issue subscription condition, the network issue subscription condition includes specified subscription information. The specified subscription information includes one or more of various information included in the first information about the network issue. For example, the specified subscription information includes the coverage, the rate, and the location; or the specified subscription information includes the object (such as the location information) of the network issue.

From the foregoing description of step 2, the second apparatus continuously obtains the specified and latest network issue by sending the second request to the vendor network device. This manages, controls, and resolves the specified network issue in time, and improve network operation&maintenance efficiency.

The second request implements a subscription (subscription) function, and is also referred to as a subscription request.

At least one of step 1 and step 2 is performed. In addition, in response to both step 1 and step 2 being performed, step 1 is performed before step 2, or is performed after step 2.

S302: The first apparatus sends the first information to the second apparatus, and the second apparatus receives the first information from the first apparatus.

With reference to the foregoing descriptions of the first information about the network issue in Table 1, Table 4, and Table 7, the first apparatus sends at least one of the identification information of the network issue, the diagnosis information of the network issue, and the recovery information of the network issue to the second apparatus. In at least one embodiment, that the first apparatus sends the first information to the second apparatus includes the following several implementations:

Implementation 1: The identification information of the network issue, the diagnosis information of the network issue, and the recovery information of the network issue are separately sent.

Optionally, in response to receiving the first request and/or the second request, the first apparatus separately sends the identification information of the network issue, the diagnosis information of the network issue, and the recovery information of the network issue to the second apparatus. As shown in FIG. 4, the first apparatus sends the identification information of the network issue to the second apparatus in response to receiving the query request and/or the subscription request of the identification information of the network issue from the second apparatus; the first apparatus sends the diagnosis information of the network issue to the second apparatus in response to receiving the query request and/or the subscription request of the diagnosis information of the network issue from the second apparatus; and the first apparatus sends the recovery information of the network issue to the second apparatus in response to receiving the query request and/or the subscription request of the recovery information of the network issue from the second apparatus.

Implementation 2: The identification information of the network issue and the diagnosis information of the network issue are sent in combination.

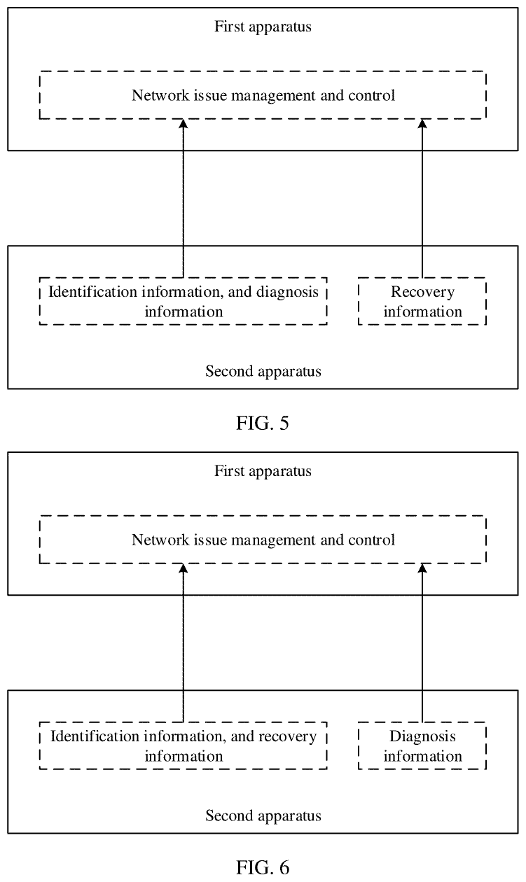

As shown in FIG. 5, the first apparatus sends the identification information of the network issue and the diagnosis information of the network issue to the second apparatus in combination, so that the second apparatus obtains the identification information of the network issue and the diagnosis information of the network issue in response to the first apparatus sending information to the second apparatus once. A quantity of times of information exchange between the apparatuses is reduced, and the second apparatus obtains the identification information and the diagnosis information in time. This more quickly determines the operation for processing the network issue and improves network operation&maintenance efficiency.

Optionally, in response to receiving the first request and/or the second request, the first apparatus sends the identification information of the network issue and the diagnosis information of the network issue to the second apparatus in combination.

Implementation 3: The identification information of the network issue and the recovery information of the network issue are sent in combination.

As shown in FIG. 6, the first apparatus sends the identification information of the network issue and the recovery information of the network issue to the second apparatus in combination, so that the second apparatus obtains the identification information of the network issue and the recovery information of the network issue in response to the first apparatus sending information to the second apparatus once. A quantity of times of information exchange between the apparatuses is reduced, and the second apparatus obtains the identification information and the recovery information in time. This more quickly determines the operation for processing the network issue and improves network operation&maintenance efficiency.

Optionally, in response to receiving the first request and/or the second request, the first apparatus sends the identification information of the network issue and the recovery information of the network issue to the second apparatus in combination.

Implementation 4: The diagnosis information of the network issue and the recovery information of the network issue are sent in combination.

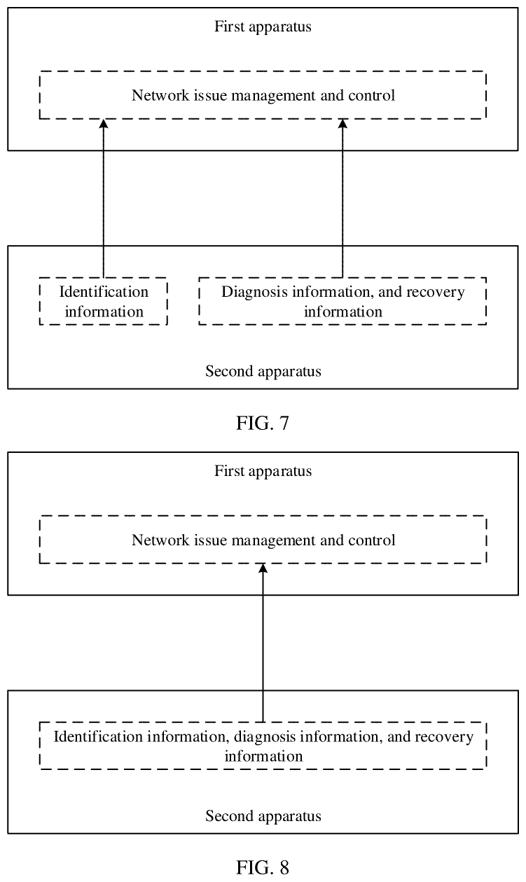

As shown in FIG. 7, the first apparatus sends the diagnosis information of the network issue and the recovery information of the network issue to the second apparatus in combination, so that the second apparatus obtains the diagnosis information of the network issue and the recovery information of the network issue in response to the first apparatus sending information to the second apparatus once. A quantity of times of information exchange between the apparatuses is reduced, and the second apparatus obtains the diagnosis information and the recovery information in time. This more quickly determines the operation for processing the network issue and improves network operation&maintenance efficiency.

Optionally, in response to receiving the first request and/or the second request, the first apparatus sends the diagnosis information of the network issue and the recovery information of the network issue to the second apparatus in combination.

Implementation 5: The identification information of the network issue, the diagnosis information of the network issue, and the recovery information of the network issue are sent in combination.

As shown in FIG. 8, the first apparatus sends the identification information of the network issue, the diagnosis information of the network issue, and the recovery information of the network issue to the second apparatus in combination, so that the second apparatus obtains the identification information of the network issue, the diagnosis information of the network issue, and the recovery information of the network issue in response to the first apparatus sending the information to the second apparatus once. A quantity of times of information exchange between the apparatuses is reduced, and the second apparatus obtains the identification information, the diagnosis information of the network issue, and the recovery information in time. This more quickly determines the operation for processing the network issue and improvise network operation&maintenance efficiency.

Optionally, in response to receiving the first request and/or the second request, the first apparatus sends the identification information of the network issue, the diagnosis information of the network issue, and the recovery information of the network issue to the second apparatus in combination.

S303: The second apparatus determines, based on the first information, the operation for processing the network issue.

The second apparatus further sends the operation for processing the network issue to the first apparatus, so that the first apparatus manages, controls, and resolves the network issue based on the operation for processing the network issue.

The following provides descriptions with several examples.

Example 1: The identification information of the network issue included in the first information is “A coverage rate of a geographical grid 1 is less than a coverage rate threshold 75%”. The second apparatus indicates the first apparatus to adjust configuration parameters of one or more network elements in the geographical grid 1, for example, increase transmit power of an access network device deployed in the geographical grid 1, so that the coverage rate of the geographical grid 1 is adjusted to be greater than or equal to 75%.

Example 2: The diagnosis information of the network issue included in the first information is “A parameter configuration of a base station 1 is inappropriate, the network issue is recoverable, a recovery suggestion is performing configuration based on a recommended parameter configuration set, and a predicted recovery result is that a coverage rate of a geographical grid 1 is greater than a coverage rate threshold 80%”. The second apparatus indicates the first apparatus to configure the base station 1 based on the recommended parameter configuration set, to adjust the coverage rate of the geographical grid 1 to be greater than 80%.

Example 3: The recovery information of the network issue included in the first information is “not recovered”. The second apparatus indicates the first apparatus to recover the network issue corresponding to the recovery information, so as to recover the network issue in time.

Example 4: The first information includes the identification information of the network issue and the diagnosis information of the network issue. The identification information is “A quantity of high-rate users in a cell 1 is less than a second quantity threshold 35”. The diagnosis information is as follows: “A cause of the network issue is interference between the cell 1 and a cell 2, the network issue is recoverable, a recovery suggestion is configuring the cell 1 and the cell 2 based on recommended cell parameters, and a predicted recovery result is that a quantity of high-rate users in the cell 1 is greater than 50%. The second apparatus indicates the first apparatus to configure the cell 1 and the cell 2 based on the recommended cell parameters, so that the quantity of high-rate users in the cell 1 is greater than 50.

Example 5: The first information includes the diagnosis information of the network issue and the recovery information of the network issue. The diagnosis information is as follows: “Load of a cell 1 is unbalanced, the network issue is recoverable, a recovery suggestion is adjusting the load of the cell 1, and a predicted recovery result is that the load of the cell 1 is balanced”. The recovery information is “not recovered”. The second apparatus indicates the first apparatus to adjust the load of the cell 1, so that the load of the cell 1 is balanced.

Example 6: The first information includes the identification information of the network issue, the diagnosis information of the network issue, and the recovery information of the network issue. The identification information is a “network element 1”. The diagnosis information is as follows: “recoverable and a predicted recovery result is that the network element 1 is successfully recovered”. The recovery information is “not recovered”. The second apparatus indicates the first apparatus to recover the network element 1, for example, the first apparatus adjusts a configuration parameter and load of the network element 1, so as to recover the network element 1 in time.

Based on the network issue information obtaining method in FIG. 3, the first apparatus is the vendor network device, and the second apparatus is the operator network device. The vendor network device sends the first information about the network issue to the operator network device in real time. The operator network device determines, in real time based on the first information, the operation for processing the network issue. In other words, the operator network device manages, controls, and resolves the network issue in the network in real time. This improvise network operation&maintenance efficiency. In addition, in response to the network issue including one or more of the following: the network fault, the network exception, or the network performance indicator exception, the operator network device further manages, controls, and resolves the network issue in the network, such as the network fault, the network exception, or the network performance indicator exception, in real time. This further improves network operation&maintenance efficiency. In addition, information such as the network fault, the network exception, or the network performance indicator exception is integrated into one piece of information (namely, the network issue), so that a plurality of interfaces between the first apparatus and the second apparatus is integrated into one interface. This reduces interface interaction complexity, improves information integration efficiency, and further improves network operation&maintenance efficiency.

In addition, for example, in response to the vendor network device detecting that a weak-coverage network issue in an area 1, but actually because the area 1 has a few users, the weak-coverage network issue in the area 1 does not need to be resolved. After receiving the network issue, the operator network device indicates the vendor network device to ignore the network issue. In other words, the operator network device further sends the operation for processing the network issue to the vendor network device, so that the vendor network device resolves a network issue that the operator network device expects to resolve, so as to prevent the vendor network device from resolving a network issue that the operator network device does not expect to resolve. This further improves network operation &maintenance efficiency.

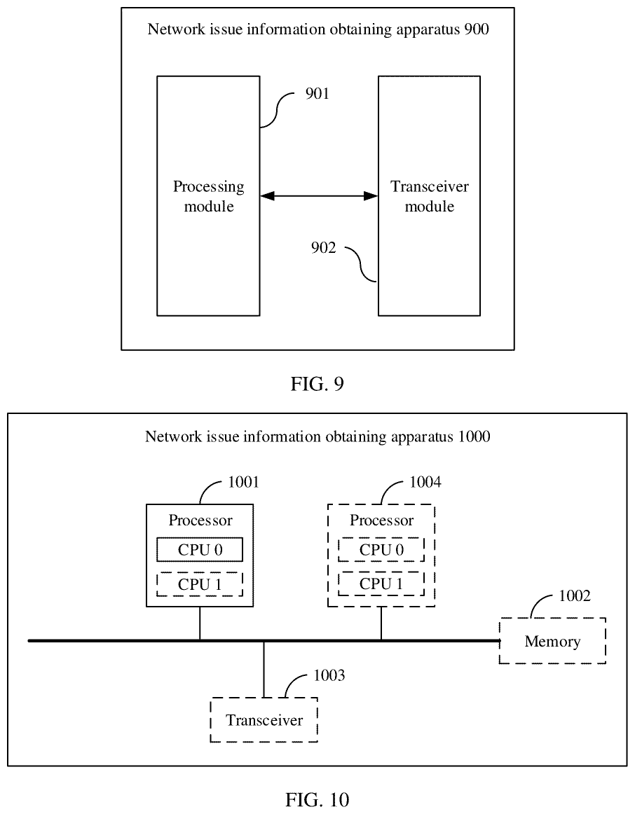

The foregoing describes in detail the network issue information obtaining method provided in at least one embodiment with reference to FIG. 3 to FIG. 8. With reference to FIG. 9 and FIG. 10, the following describes in detail a network issue information obtaining apparatus configured to perform the network issue information obtaining method provided in at least one embodiment.

For example, FIG. 9 is a schematic diagram 1 of a structure of a network issue information obtaining apparatus according to at least one embodiment. As shown in FIG. 9, the network issue information obtaining apparatus 900 includes a processing module 901 and a transceiver module 902. For ease of description, FIG. 9 shows only main components of the network issue information obtaining apparatus.

In some embodiments, the network issue information obtaining apparatus 900 is applicable to the communication system shown in FIG. 1, and performs a function of the first apparatus in the network issue information obtaining method shown in FIG. 3.

The processing module 901 is configured to determine first information about a network issue. The first information includes one or more of the following: identification information of the network issue, diagnosis information of the network issue, or recovery information of the network issue, the diagnosis information describes an analysis result of the network issue, and the recovery information describes a recovery status of the network issue.

The transceiver module 902 is configured to send the first information to a second apparatus.

For specific implementations of the network issue, the identification information of the network issue, the diagnosis information of the network issue, and the recovery information of the network issue, refer to corresponding descriptions in the network issue information obtaining method shown in FIG. 3, and details are not described herein again.

In at least one embodiment, the transceiver module 902 is further configured to receive a first request from the second apparatus. The first request includes one or more of the following: a network issue query condition or network issue indication information. The network issue query condition is used to indicate the first apparatus to feed back the first information that meets the network issue query condition. The network issue indication information indicates the first apparatus to feed back one or more of the following: the identification information of the network issue, the diagnosis information of the network issue, or the recovery information of the network issue.

In at least one embodiment, the transceiver module 902 is further configured to receive a second request from the second apparatus. The second request carries a network issue subscription condition, and the network issue subscription condition is used to indicate that the first apparatus feeds back the first information in response to the first information that meets the network issue subscription condition being generated or updated.

Optionally, the transceiver module 902 includes a receiving module and a sending module (not shown in FIG. 9). The sending module is configured to implement a sending function of the network issue information obtaining apparatus 900, and the receiving module is configured to implement a receiving function of the network issue information obtaining apparatus 900.

Optionally, the network issue information obtaining apparatus 900 further includes a storage module (not shown in FIG. 9), and the storage module stores a program or instructions. In response to the processing module 901 executing the program or the instructions, the network issue information obtaining apparatus 900 performs a function of the first apparatus in the network issue information obtaining method shown in FIG. 3.

The processing module 901 in the network issue information obtaining apparatus 900 is implemented by a processor or a processor-related circuit component, and is a processor or a processing unit. The transceiver module 902 is implemented by a transceiver or a transceiver-related circuit component, and is a transceiver or a transceiver unit.

The network issue information obtaining apparatus 900 is a vendor network device, or is a chip (system) or another component or part disposed in the vendor network device, or is an apparatus including the vendor network device. This is not limited in embodiments described herein.

In addition, for technical effect of the network issue information obtaining apparatus 900, refer to the technical effect of the network issue information obtaining method shown in FIG. 3, and details are not described herein again.

In some other embodiments, the network issue information obtaining apparatus 900 is applicable to the communication system shown in FIG. 1, and performs a function of the second apparatus in the network issue information obtaining method shown in FIG. 3.

The transceiver module 902 is configured to receive first information about a network issue from a first apparatus. The first information includes one or more of the following: identification information of the network issue, diagnosis information of the network issue, or recovery information of the network issue, the diagnosis information describes an analysis result of the network issue, and the recovery information describes a recovery status of the network issue.

The processing module 901 is configured to determine, based on the first information, an operation for processing the network issue.

For specific implementations of the network issue, the identification information of the network issue, the diagnosis information of the network issue, and the recovery information of the network issue, refer to corresponding descriptions in the network issue information obtaining method shown in FIG. 3, and details are not described herein again.

In at least one embodiment, the transceiver module 902 is further configured to send a first request to the first apparatus. The first request includes one or more of the following: a network issue query condition or network issue indication information. The network issue query condition is used to indicate the first apparatus to feed back the first information that meets the network issue query condition. The network issue indication information indicates the first apparatus to feed back one or more of the following: the identification information of the network issue, the diagnosis information of the network issue, or the recovery information of the network issue.

In at least one embodiment, the transceiver module 902 is further configured to send a second request to the first apparatus. The second request carries a network issue subscription condition, and the network issue subscription condition is used to indicate that the first apparatus feeds back the first information in response to the first information that meets the network issue subscription condition being generated or updated.

Optionally, the transceiver module 902 includes a receiving module and a sending module (not shown in FIG. 9). The sending module is configured to implement a sending function of the network issue information obtaining apparatus 900, and the receiving module is configured to implement a receiving function of the network issue information obtaining apparatus 900.

Optionally, the network issue information obtaining apparatus 900 further includes a storage module (not shown in FIG. 9), and the storage module stores a program or instructions. In response to the processing module 901 executing the program or the instructions, the network issue information obtaining apparatus 900 performs a function of the second apparatus in the network issue information obtaining method shown in FIG. 3.

The processing module 901 in the network issue information obtaining apparatus 900 is implemented by a processor or a processor-related circuit component, and is a processor or a processing unit. The transceiver module 902 is implemented by a transceiver or a transceiver-related circuit component, and is a transceiver or a transceiver unit.

The network issue information obtaining apparatus 900 is the operator network device shown in FIG. 1, or is a chip (system) or another component or part disposed in the operator network device, or an apparatus including the operator network device. This is not limited in at least one embodiment.

In addition, for technical effect of the network issue information obtaining apparatus 900, refer to the technical effect of the network issue information obtaining method shown in FIG. 3, and details are not described herein again.

For example, FIG. 10 is a schematic diagram 2 of a structure of a network issue information obtaining apparatus according to at least one embodiment. The network issue information obtaining apparatus is a vendor network device or an operator network device, or is a chip (system) or another component or part that is disposed in the vendor network device or the operator network device. As shown in FIG. 10, the network issue information obtaining apparatus 1000 includes a processor 1001. Optionally, the network issue information obtaining apparatus 1000 further includes a memory 1002 and/or a transceiver 1003. The processor 1001 is coupled to the memory 1002 and the transceiver 1003, for example, is connected to the memory and the transceiver through a communication bus.

The following describes components of the network issue information obtaining apparatus 1000 in detail with reference to FIG. 10.

The processor 1001 is a control center of the network issue information obtaining apparatus 1000, and is a processor, or is a collective name of a plurality of processing elements. For example, the processor 1001 is one or more central processing units (central processing units, CPUs), or is an application-specific integrated circuit (application-specific integrated circuit, ASIC), or is configured as one or more integrated circuits for implementing at least one embodiment, for example, one or more microprocessors (digital signal processors, DSPs) or one or more field programmable gate arrays (field programmable gate arrays, FPGAs).

Optionally, the processor 1001 performs various functions of the network issue information obtaining apparatus 1000 by running or executing a software program stored in the memory 1002 and invoking data stored in the memory 1002.

During a specific implementation, in an embodiment, the processor 1001 includes one or more CPUs, for example, a CPU 0 and a CPU 1 in FIG. 10.

During a specific implementation, in an embodiment, the network issue information obtaining apparatus 1000 further includes a plurality of processors, for example, the processor 1001 and a processor 1004 shown in FIG. 10. Each of the processors is a single-core processor (single-CPU), or is a multi-core processor (multi-CPU). The processor herein is one or more devices, circuits, and/or processing cores configured to process data (for example, computer program instructions).

The memory 1002 is configured to store a software program for performing the solutions of at least one embodiment, and the processor 1001 controls execution of the software program. For a specific implementation, refer to the foregoing method embodiment, and details are not described herein again.

Optionally, the memory 1002 is a read-only memory (read-only memory, ROM) or another type of static storage device capable of storing static information and instructions, or is a random access memory (random access memory, RAM) or another type of dynamic storage device capable of storing information and instructions, or is an electrically erasable programmable read-only memory (electrically erasable programmable read-only memory, EEPROM), a compact disc read-only memory (compact disc read-only memory, CD-ROM) or other compact disc storage, optical disc storage (including a compressed optical disc, a laser disc, an optical disc, a digital versatile disc, a Blu-ray disc, or the like), a magnetic disk storage medium or another magnetic storage device, or any other medium capable of carrying or storing expected program code in a form of an instruction or a data structure and capable of being accessed by a computer. However, this is not limited. The memory 1002 is integrated with the processor 1001, or exists independently, and is coupled to the processor 1001 through an interface circuit (not shown in FIG. 10) of the network issue information obtaining apparatus 1000. This is not specifically limited in at least one embodiment.

The transceiver 1003 is configured to communicate with another network issue information obtaining apparatus. For example, the network issue information obtaining apparatus 1000 is a terminal device, and the transceiver 1003 is configured to communicate with a network device or communicate with another terminal device. For another example, the network issue information obtaining apparatus 1000 is a network device, and the transceiver 1003 is configured to communicate with a terminal device or communicate with another network device.

Optionally, the transceiver 1003 includes a receiver and a transmitter (not separately shown in FIG. 10). The receiver is configured to implement a receiving function, and the transmitter is configured to implement a sending function.

Optionally, the transceiver 1003 is integrated with the processor 1001, or exists independently, and is coupled to the processor 1001 through an interface circuit (not shown in FIG. 10) of the network issue information obtaining apparatus 1000. This is not specifically limited in at least one embodiment.

The structure of the network issue information obtaining apparatus 1000 shown in FIG. 10 does not constitute a limitation on the network issue information obtaining apparatus. An actual network issue information obtaining apparatus includes more or fewer components than those shown in the figure, or some components is combined, or different component arrangements is used.

In addition, for technical effect of the network issue information obtaining apparatus 1000, refer to the technical effect of the network issue information obtaining method in the foregoing method embodiment, and details are not described herein again.

At least one embodiment provides a communication system. The communication system includes the foregoing first apparatus and second apparatus, and the first apparatus is connected to the second apparatus. The first apparatus is configured to perform S301 and S302 in the method embodiment shown in FIG. 3. The second apparatus is configured to perform S302 and S303 in the method embodiment shown in FIG. 3. In addition, for a specific implementation and technical effect of the communication system, refer to the network issue information obtaining method in the foregoing method embodiment, and details are not described herein again.

The processor in at least one embodiment is a central processing unit (central processing unit, CPU), or the processor is another general-purpose processor, a digital signal processor (digital signal processor, DSP), an application-specific integrated circuit (application-specific integrated circuit, ASIC), a field programmable gate array (field programmable gate array, FPGA), or another programmable logic device, discrete gate or transistor logic device, discrete hardware component, or the like. The general-purpose processor is a microprocessor, or the processor is any conventional processor or the like.

The memory in at least one embodiment is a volatile memory or a nonvolatile memory, or includes a volatile memory and a nonvolatile memory. The nonvolatile memory is a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory is a random access memory (random access memory, RAM), used as an external cache. By way of example and not limitation, random access memories (random access memory, RAM) in many forms is used, for example, a static random access memory (static RAM, SRAM), a dynamic random access memory (DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

All or some of the foregoing embodiments is implemented using software, hardware (for example, a circuit), firmware, or any combination thereof. In response to software being used to implement embodiments, all or some of the foregoing embodiments is implemented in a form of a computer program product. The computer program product includes one or more computer instructions or computer programs. In response to the computer instructions or the computer programs being loaded and executed on the computer, the procedure or functions according to at least one embodiment are all or partially generated. The computer is a general-purpose computer, a dedicated computer, a computer network, or other programmable apparatuses. The computer instructions is stored in a computer-readable storage medium or is transmitted from a computer-readable storage medium to another computer-readable storage medium. For example, the computer instructions is transmitted from a website, computer, server, or data center to another website, computer, server, or data center in a wired (for example, infrared, radio, and microwave) manner. The computer-readable storage medium is any usable medium accessible by a computer, or a data storage device, such as a server or a data center, integrating one or more usable media. The usable medium is a magnetic medium (for example, a floppy disk, a hard disk, or a magnetic tape), an optical medium (for example, a DVD), or a semiconductor medium. The semiconductor medium is a solid-state drive.

The term “and/or” in this specification describes only an association relationship between associated objects and represents that three relationships exist. For example, A and/or B represent the following three cases: Only A exists, both A and B exist, and only B exists. A and B is singular or plural. In addition, the character “/” in embodiments described herein usually indicates an “or” relationship between the associated objects, but also indicates an “and/or” relationship. For details, refer to the context for understanding.

In at least one embodiment, “at least one” means one or more, and “a plurality of” means two or more. “At least one of the following items (pieces)” or a similar expression thereof indicates any combination of these items, including a single item (piece) or any combination of a plurality of items (pieces). For example, at least one item (piece) of a, b, or c indicates: a, b, c, a and b, a and c, b and c, or a, b, and c, where a, b, and c is singular or plural.

Sequence numbers of the foregoing processes do not mean execution sequences in at least one embodiment. The execution sequences of the processes should be determined according to functions and internal logic of the processes, and should not be construed as any limitation on the implementation processes of at least one embodiment.

A person of ordinary skill in the art is aware that, in combination with the examples described in embodiments disclosed herein, units and algorithm steps is implemented by electronic hardware or a combination of computer software and electronic hardware. Whether the functions are performed by hardware or software depends on particular applications and design constraint conditions of the technical solutions. A person skilled in the art is able to use different methods to implement the described functions, but the implementation does not go beyond the scope of embodiments described herein.

A person skilled in the art understands that, for the purpose of convenient and brief description, for a detailed working process of the foregoing system, apparatus, and unit, refer to a corresponding process in the foregoing method embodiments. Details are not described herein again.

In the several embodiments described herein, the disclosed system, apparatus, and method is implemented in other manners. For example, the described apparatus embodiments are merely examples. For example, division into the units is merely logical function division. There is another division manner during actual implementation. For example, a plurality of units or components is combined or integrated into another system, or some features is ignored or not performed. In addition, the displayed or discussed mutual couplings or direct couplings or communication connections is implemented through some interfaces. The indirect couplings or communication connections between the apparatuses or units is implemented in electronic, mechanical, or other forms.

The units described as separate parts may or may not be physically separate, and parts displayed as units may or may not be physical units, is located in one position, or is distributed on a plurality of network units. Some or all of the units is selected based on actual usage to achieve the objectives of the solutions of embodiments.

In addition, function units in at least one embodiment are integrated into one processing unit, each of the units exist alone physically, or two or more units are integrated into one unit.

In response to the functions being implemented in the form of a software function unit and sold or used as an independent product, the functions is stored in a computer-readable storage medium. Based on such an understanding, the technical solutions of embodiments described herein essentially, or the part contributing to the conventional technology, or some of the technical solutions is implemented in a form of a software product. The computer software product is stored in a storage medium, and includes several instructions for instructing a computer device (which is a personal computer, a server, or a network device) to perform all or some of the steps of the methods described in embodiments herein. The foregoing storage medium includes any medium that stores program code, such as a USB flash drive, a removable hard disk, a read-only memory (read-only memory, ROM), a random access memory (random access memory, RAM), a magnetic disk, or an optical disc.

The foregoing descriptions are merely specific implementations of at least one embodiment, but are not intended to limit the protection scope of embodiments described herein. Any variation or replacement readily figured out by a person skilled in the art within the technical scope disclosed in embodiments herein shall fall within the protection scope of at least one embodiment. Therefore, the protection scope of embodiments described herein shall be subject to the protection scope of the claims.

1. A network issue information sending method, applied to a first apparatus, wherein the method comprises:
determining first information about a network issue, wherein the determining the first information includes determining one or more of the following: identification information of the network issue, diagnosis information of the network issue, or recovery information of the network issue, the diagnosis information describes an analysis result of the network issue, and the recovery information describes a recovery status of the network issue; and
sending the first information to a second apparatus.

2. The method according to claim 1, wherein the determining the first information about the network issue includes determining one or more of the following: a network fault, a network exception, or a network performance indicator exception.

3. The method according to claim 1, wherein the determining the identification information of the network issue includes determining one or more of the following: a type of the network issue, or an object of the network issue;
wherein the determining the type of the network issue includes determining one or more of the following: coverage, a rate, a capacity, a device fault, service experience, mobility, or energy consumption; and
wherein the determining the object of the network issue includes determining one or more of the following: location information, a network element, a cell, or a terminal user.

4. The method according to claim 3, wherein the determining the coverage includes determining one or more of a coverage rate is less than a first coverage rate threshold, a coverage rate is greater than a second coverage rate threshold, reference signal received power is less than a reference signal received power threshold, a signal to interference plus noise ratio is less than a signal to interference plus noise ratio threshold, or there is no coverage;
wherein the determining the coverage rate includes determining one or more of the rate is less than a first rate threshold, a quantity of low-rate users is greater than a first quantity threshold, or a quantity of high-rate users is less than a second quantity threshold, wherein the determining the quantity of the low-rate user includes determining a user whose rate is less than a second rate threshold, and the determining the quantity of the high-rate user includes determining a user whose rate is greater than a third rate threshold;
wherein the determining the capacity includes determining one or more of a network load is greater than a load threshold, a network load is unbalanced, or a network is congested;
wherein the determining the device fault includes determining one or more of a base station fault, a fronthaul fault, an optical interface fault, a clock fault, a cell fault, or a standing wave fault;
wherein the determining the service experience includes determining one or more of a delay is greater than a delay threshold, a delay jitter is greater than a delay jitter threshold, an access success rate is less than an access success rate threshold, a call drop rate is greater than a call drop rate threshold, a packet loss rate is greater than a packet loss rate threshold, or a mean opinion score is less than a mean opinion score threshold, wherein the mean opinion score describes voice or video quality;
wherein the determining the mobility includes determining one or more of a handover success rate is less than a handover success rate threshold, a premature handover rate is greater than a premature handover rate threshold, a delayed handover rate is greater than a delayed handover rate threshold, or a ping-pong handover rate is greater than a ping-pong handover rate threshold; and
wherein the determining the energy consumption includes determining one or more of the energy consumption is greater than an energy consumption threshold, or a traffic volume is lower than a traffic volume threshold but the energy consumption is greater than an energy consumption threshold.

5. The method according to claim 1, wherein the determining the diagnosis information of the network issue includes determining one or more of a cause of the network issue, a recovery capability corresponding to the network issue, a recovery suggestion for the network issue, or a predicted recovery result of the network issue;
wherein the determining the recovery capability includes determining the first apparatus is able to recover the network issue or the first apparatus is not able to recover the network issue;
wherein the determining the recovery suggestion for the network issue includes determining an operation of the first apparatus to recover the network issue; and
wherein the determining the predicted recovery result of the network issue includes determining a predicted network performance indicator obtained after the network issue is recovered.

6. A network issue information obtaining method, applied to a second apparatus, wherein the method comprises:
receiving first information about a network issue from a first apparatus, wherein the receiving the first information includes receiving one or more of identification information of the network issue, diagnosis information of the network issue, or recovery information of the network issue, wherein the receiving the diagnosis information includes receiving the diagnosis information describing an analysis result of the network issue, and wherein the receiving the recovery information includes receiving the recovery information describing a recovery status of the network issue; and
determining, based on the first information, an operation for processing the network issue.

7. The method according to claim 6, wherein the receiving the first information about the network issue includes receiving one or more of a network fault, a network exception, or a network performance indicator exception.

8. The method according to claim 6, wherein the receiving the identification information of the network issue includes receiving one or more of a type of the network issue, or an object of the network issue;
wherein the receiving the type of the network issue includes receiving one or more of coverage, a rate, a capacity, a device fault, service experience, mobility, or energy consumption; and
wherein the receiving the object of the network issue includes receiving one or more of location information, a network element, a cell, or a terminal user.

9. The method according to claim 8, wherein the receiving the coverage includes receiving one or more of a coverage rate is less than a first coverage rate threshold, a coverage rate is greater than a second coverage rate threshold, reference signal received power is less than a reference signal received power threshold, a signal to interference plus noise ratio is less than a signal to interference plus noise ratio threshold, or there is no coverage;
wherein the receiving the coverage rate includes receiving one or more of the rate is less than a first rate threshold, a quantity of low-rate users is greater than a first quantity threshold, or a quantity of high-rate users is less than a second quantity threshold, wherein the receiving the quantity of the low-rate user includes receiving the quantity of a user whose rate is less than a second rate threshold, and the receiving the quantity of the high-rate user includes receiving the quantity of a user whose rate is greater than a third rate threshold;
wherein the receiving the capacity includes receiving one or more of a network load is greater than a load threshold, a network load is unbalanced, or a network is congested;
wherein the receiving the device fault includes receiving one or more of a base station fault, a fronthaul fault, an optical interface fault, a clock fault, a cell fault, or a standing wave fault;
wherein the receiving the service experience includes receiving one or more of a delay is greater than a delay threshold, a delay jitter is greater than a delay jitter threshold, an access success rate is less than an access success rate threshold, a call drop rate is greater than a call drop rate threshold, a packet loss rate is greater than a packet loss rate threshold, or a mean opinion score is less than a mean opinion score threshold, wherein the mean opinion score describes voice or video quality;
wherein the receiving the mobility includes receiving one or more of a handover success rate is less than a handover success rate threshold, a premature handover rate is greater than a premature handover rate threshold, a delayed handover rate is greater than a delayed handover rate threshold, or a ping-pong handover rate is greater than a ping-pong handover rate threshold; and
wherein the receiving the energy consumption includes receiving one or more of the energy consumption is greater than an energy consumption threshold, or a traffic volume is lower than a traffic volume threshold but the energy consumption is greater than an energy consumption threshold.

10. The method according to claim 6, wherein the receiving the diagnosis information of the network issue includes receiving one or more of a cause of the network issue, a recovery capability corresponding to the network issue, a recovery suggestion for the network issue, or a predicted recovery result of the network issue;
wherein the receiving the recovery capability corresponding to the network issue includes receiving: the first apparatus is able to recover the network issue or the first apparatus is not able to recover the network issue;
wherein the receiving the recovery suggestion for the network issue includes receiving an operation of the first apparatus to recover the network issue; and
wherein the receiving the predicted recovery result of the network issue includes receiving a predicted network performance indicator obtained after the network issue is recovered.

11. An apparatus, comprising:
at least one processor; and
a memory coupled to the at least one processor and having program instructions stored thereon which, when executed by the at least one processor, cause the processor to:
determine first information about a network issue, wherein the first information includes one or more of the following: identification information of the network issue, diagnosis information of the network issue, or recovery information of the network issue, the diagnosis information describes an analysis result of the network issue, and the recovery information describes a recovery status of the network issue; and
send the first information to a second apparatus.

12. The apparatus according to claim 11, wherein the network issue includes one or more of the following: a network fault, a network exception, or a network performance indicator exception.

13. The apparatus according to claim 11, wherein the identification information of the network issue includes one or more of the following: a type of the network issue, or an object of the network issue;
the type of the network issue includes one or more of the following: coverage, a rate, a capacity, a device fault, service experience, mobility, or energy consumption; and
the object of the network issue includes one or more of the following: location information, a network element, a cell, or a terminal user.

14. The apparatus according to claim 13, wherein the coverage corresponds to one or more of the following network issues: a coverage rate is less than a first coverage rate threshold, a coverage rate is greater than a second coverage rate threshold, reference signal received power is less than a reference signal received power threshold, a signal to interference plus noise ratio is less than a signal to interference plus noise ratio threshold, or there is no coverage;
the rate corresponds to one or more of the following network issues: the rate is less than a first rate threshold, a quantity of low-rate users is greater than a first quantity threshold, or a quantity of high-rate users is less than a second quantity threshold, wherein the low-rate user is a user whose rate is less than a second rate threshold, and the high-rate user is a user whose rate is greater than a third rate threshold;
the capacity corresponds to one or more of the following network issues: network load is greater than a load threshold, network load is unbalanced, or a network is congested;
the device fault corresponds to one or more of the following network issues: a base station fault, a fronthaul fault, an optical interface fault, a clock fault, a cell fault, or a standing wave fault;
the service experience corresponds to one or more of the following network issues: a delay is greater than a delay threshold, a delay jitter is greater than a delay jitter threshold, an access success rate is less than an access success rate threshold, a call drop rate is greater than a call drop rate threshold, a packet loss rate is greater than a packet loss rate threshold, or a mean opinion score is less than a mean opinion score threshold, wherein the mean opinion score describes voice or video quality;
the mobility corresponds to one or more of the following network issues: a handover success rate is less than a handover success rate threshold, a premature handover rate is greater than a premature handover rate threshold, a delayed handover rate is greater than a delayed handover rate threshold, or a ping-pong handover rate is greater than a ping-pong handover rate threshold; and
the energy consumption corresponds to one or more of the following network issues: the energy consumption is greater than an energy consumption threshold, or a traffic volume is lower than a traffic volume threshold but the energy consumption is greater than an energy consumption threshold.

15. The apparatus according to claim 11, wherein the diagnosis information of the network issue includes one or more of the following: a cause of the network issue, a recovery capability corresponding to the network issue, a recovery suggestion for the network issue, or a predicted recovery result of the network issue;
the recovery capability corresponding to the network issue includes: the first apparatus is able to recover the network issue or the first apparatus is not able to recover the network issue;
the recovery suggestion for the network issue includes an operation of the first apparatus to recover the network issue; and
the predicted recovery result of the network issue includes a predicted network performance indicator obtained after the network issue is recovered.

16. An apparatus, comprising:
at least one processor; and
a memory coupled to the at least one processor and having program instructions stored thereon which, when executed by the at least one processor, cause the processor to:
receive first information about a network issue from a first apparatus, wherein the first information includes one or more of the following: identification information of the network issue, diagnosis information of the network issue, or recovery information of the network issue, the diagnosis information describes an analysis result of the network issue, and the recovery information describes a recovery status of the network issue; and
determine, based on the first information, an operation for processing the network issue.

17. The apparatus according to claim 16, wherein the network issue includes one or more of the following: a network fault, a network exception, or a network performance indicator exception.

18. The apparatus according to claim 16, wherein the identification information of the network issue includes one or more of the following: a type of the network issue, or an object of the network issue;
the type of the network issue includes one or more of the following: coverage, a rate, a capacity, a device fault, service experience, mobility, or energy consumption; and
the object of the network issue includes one or more of the following: location information, a network element, a cell, or a terminal user.

19. The apparatus according to claim 18, wherein the coverage corresponds to one or more of the following network issues: a coverage rate is less than a first coverage rate threshold, a coverage rate is greater than a second coverage rate threshold, reference signal received power is less than a reference signal received power threshold, a signal to interference plus noise ratio is less than a signal to interference plus noise ratio threshold, or there is no coverage;
the rate corresponds to one or more of the following network issues: the rate is less than a first rate threshold, a quantity of low-rate users is greater than a first quantity threshold, or a quantity of high-rate users is less than a second quantity threshold, wherein the low-rate user is a user whose rate is less than a second rate threshold, and the high-rate user is a user whose rate is greater than a third rate threshold;
the capacity corresponds to one or more of the following network issues: network load is greater than a load threshold, network load is unbalanced, or a network is congested;
the device fault corresponds to one or more of the following network issues: a base station fault, a fronthaul fault, an optical interface fault, a clock fault, a cell fault, or a standing wave fault;
the service experience corresponds to one or more of the following network issues: a delay is greater than a delay threshold, a delay jitter is greater than a delay jitter threshold, an access success rate is less than an access success rate threshold, a call drop rate is greater than a call drop rate threshold, a packet loss rate is greater than a packet loss rate threshold, or a mean opinion score is less than a mean opinion score threshold, wherein the mean opinion score describes voice or video quality;
the mobility corresponds to one or more of the following network issues: a handover success rate is less than a handover success rate threshold, a premature handover rate is greater than a premature handover rate threshold, a delayed handover rate is greater than a delayed handover rate threshold, or a ping-pong handover rate is greater than a ping-pong handover rate threshold; and
the energy consumption corresponds to one or more of the following network issues: the energy consumption is greater than an energy consumption threshold, or a traffic volume is lower than a traffic volume threshold but the energy consumption is greater than an energy consumption threshold.

20. The apparatus according to claim 16, wherein the diagnosis information of the network issue includes one or more of the following: a cause of the network issue, a recovery capability corresponding to the network issue, a recovery suggestion for the network issue, or a predicted recovery result of the network issue;
the recovery capability corresponding to the network issue includes: the first apparatus is able to recover the network issue or the first apparatus is not able to recover the network issue;
the recovery suggestion for the network issue includes an operation of the first apparatus to recover the network issue; and
the predicted recovery result of the network issue includes a predicted network performance indicator obtained after the network issue is recovered.
